(19) United States
(12) Patent Application Publication
(10) Pub. No.: US 2024/0391010 A1
(43) Pub. Date: Nov. 28, 2024

(54) WEAVING CONTROL METHOD, WELDING CONTROL DEVICE, WELDING SYSTEM, WELDING METHOD, AND WEAVING CONTROL PROGRAM

(71) Applicant: KOBELCO ROBOTiX Co., Ltd., Fujisawa-shi (JP)

(72) Inventors: Futoshi NAKATA, Kanagawa (JP); Hirofumi KAWASAKI, Kanagawa (JP); Shinobu TODA, Kanagawa (JP); Masaru KODAMA, Kanagawa (JP)

(73) Assignee: KOBELCO ROBOTiX Co., Ltd., Fujisawa-shi (JP)

(21) Appl. No.: 18/693,836

(22) PCT Filed: Aug. 2, 2022
(86) PCT No.: PCT/JP2022/029718

§ 371 Date: Mar. 20, 2024

(30) Foreign Application Priority Data
Sep. 24, 2021 (JP) 2021-156169

(51) Int. Cl. B23K 9/02; B23K 9/12

(52) U.S. Cl. CPC B23K 9/0216; B23K 9/126

(57) ABSTRACT

Provided is a weaving control method for obtaining an excellent weld quality of various kinds of position welding such as flat welding, horizontal welding, and vertical welding using a portable welding robot that moves on a guide rail. The weaving control method includes: a setting step of setting at least a condition of a weaving reference trajectory relating to a reference distance for determining a weaving pattern; and a speed condition calculation step of calculating a speed condition for giving an instruction to a robot movement mechanism that moves the portable welding robot for each of a plurality of predetermined direction components based on the weaving pattern determined based on the setting step, in which an instruction of a stop signal and an instruction of a departure signal to be given immediately after instructing the stop signal or after the lapse of a predetermined stop time are synchronized with the speed condition of each of the plurality of direction components calculated in the speed condition calculation step at least when a weaving end is reached.

### TECHNICAL FIELD

The present invention relates to a weaving control method, a welding control device, a welding system, a welding method, and a weaving control program for welding a workpiece having a groove using a portable welding robot.

### BACKGROUND ART

For welding work in a factory in manufacturing a welded structure in shipbuilding, a steel frame, a bridge, or the like, the working efficiency is important, and a system to which a large stationary multi-axis welding robot is applied mainly for flat position welding is widely used. The system to which the stationary multi-axis welding robot is applied is a welding robot system of a type in which an object to be welded (hereinafter, also referred to as “workpiece”) is provided in a stationary positioner and is automatically welded using a multi-axis welding robot. On the other hand, for site welding or welding of a small member or a member having a complicated shape to which the large multi-axis welding robot cannot be applied, manual welding such as semi-automatic welding or automatic welding using a small lightweight portable welding robot that can be carried by one worker is widely used. In particular, the application of the portable welding robot to site welding is recommended by utilizing the feature that the portable welding robot can be carried.

Incidentally, in an arc welding method, to obtain sufficient penetration and an appropriate weld reinforcement shape, a weld joint of an object to be welded is welded in a weld line direction while swinging a welding torch in a groove width direction or a groove depth direction of the weld joint. The swinging of the welding torch is called “weaving”, “oscillating”, or “moving”, and a weaving pattern varies depending on welding positions. In the following description, the swinging of the welding torch will be referred to as “weaving”, and a trajectory formed by the weaving will be referred to as “weaving pattern”. By performing the weaving of the welding torch using the multi-axis welding robot, the portable welding robot, or the like described above, sufficient penetration and an appropriate weld reinforcement shape can be obtained, and welding can be automated.

Here, Patent Literature 1 discloses a stationary welding device in which an articulated welding robot and a rotary positioner are combined, and discloses that, in horizontal welding, weaving is performed in a serrated shape to obtain appropriate weld overlay as illustrated in FIG. 17 of Patent Literature 1. In vertical welding, weaving is performed in a rectangular shape to obtain appropriate weld overlay.

As a small lightweight welding device where movement or welding preparation is simple, Patent Literature 2 discloses an automatic welding device in which three orthogonal axes in X, Y, and Z directions and a drive shaft for swinging a welding torch are incorporated. Patent Literature 2 discloses that a motor is controlled based on a welding speed read from a shared memory to set the welding speed to a predetermined speed, a weld swing control unit controls the motor for each of weld layers in each of regions to swing a welding torch portion with an amplitude corresponding to a bottom surface width.

Patent Literature 3 discloses a portable automatic welding device that moves on a guide rail and where a T-axis along which a welding torch is tilted is added in addition to three orthogonal axes in X, Y, and Z directions. Patent Literature 3 discloses that a section between two points at which a groove shape is measured is divided into regions, welding conditions for each of the regions are determined by performing linear interpolation on welding speeds calculated at one leading point and one trailing point, oscillation conditions for each of the regions are set according to the determined welding speed, and the welding torch oscillates during welding.

### CITATION LIST

### Patent Literature

[PATENT LITERATURE 1] JP2013-202673A
[PATENT LITERATURE 2] JPH08-15665A
[PATENT LITERATURE 3] JP2021-16881A

### SUMMARY OF INVENTION

### Technical Problem

However, regarding the weaving in vertical welding and horizontal welding described in Patent Literature 1, the complicated weaving pattern such as a serrated shape or a rectangular shape is applied to obtain appropriate weld overlay. The special weaving pattern can be easily implemented by using an articulated robot having a plurality of degrees of freedom, but the application of an automatic welding device including the articulated robot as a component to site welding as in the portable welding robot is not practical and is difficult even considering device weight, installation time, or the like.

In the welding device disclosed in Patent Literature 2 or 3, weaving is performed by reciprocating a welding torch during welding using a swing mechanism dedicated to weaving or a movement mechanism that moves the welding torch in a groove width direction in the portable welding robot. In either case, weaving conditions are set according to the determined welding speed, and the welding torch is weaved during welding. That is, since the welding conditions vary depending on the determined welding speed, it is necessary to constantly manage the welding speed and the weaving conditions in pairs.

Here, FIG. 28A illustrates movement of weaving when a weaving cycle is appropriate at the determined welding speed. Here, if the welding speed further increases, as illustrated in FIG. 28B, gaps of the weaving pattern are widened, there are locations that arc cannot reach in the gaps of the weaving pattern, and lack of penetration in a groove is concerned.

In weaving, a stop time may be provided at both weaving ends such that sufficient penetration of a groove wall can be obtained. The purpose of providing the stop time at both weaving ends is to maintain welding arc at the stop location to increase heat input such that sufficient penetration can be obtained. However, in the portable welding robot described in Patent Literature 2 or 3, a welding torch moves in the weld line direction while being maintained at both weaving ends. Accordingly, welding arc as a heat input point moves, and thus the original purpose cannot be achieved. If the welding speed further increases, as illustrated in FIG. 29, gaps of the weaving pattern are widened, there are locations that the arc cannot reach in the gaps of the weaving pattern, and lack of penetration in a groove is concerned.

The concerned event illustrated in FIG. 28B or FIG. 29 occurs because the weaving and the movement in the weld line direction occur independently of each other without being synchronized with each other. To prevent the event from occurring, it is necessary to manage weaving conditions such as cycle, width, or stop time for each determined welding speed. When the weld length increases such that a plurality of measuring points of a groove shape for determining a welding speed are present, the management becomes complicated, which may also cause error in welding conditions including weaving conditions.

The present invention has been made considering the above-described problems, and an object thereof is to provide a weaving control method, a welding control device, a welding system, a welding method, and a weaving control program for obtaining an excellent weld quality of various kinds of position welding such as flat welding, horizontal welding, and vertical welding using a portable welding robot that moves on a guide rail.

### Solution to Problem

The above-described object of the present invention is achieved by the following configuration of [1] relating to the weaving control method.

[1] A weaving control method for welding a workpiece having a groove using a portable welding robot that moves on a guide rail, the weaving control method including:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, in which
an instruction of a stop signal and an instruction of a departure signal to be given immediately after instructing the stop signal or after the lapse of a predetermined stop time under the speed condition of each of the plurality of direction components calculated in the speed condition calculation step are synchronized with each other at least when a weaving end is reached.

The above-described object of the present invention is achieved by the following configuration of [2] relating to the welding control device.

[2] A welding control device used in weaving control for welding a workpiece having a groove using a portable welding robot that moves on a guide rail, the welding control device comprising:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, in which
the welding control device has a function of synchronizing an instruction of a stop signal and an instruction of a departure signal to be given immediately after instructing the stop signal or after the lapse of a predetermined stop time under the speed condition of each of the plurality of direction components calculated in the speed condition calculation step with each other at least when a weaving end is reached.

The above-described object of the present invention is achieved by the following configuration of [3] relating to the welding system.

[3] A welding system including the welding control device according to [2].

The above-described object of the present invention is achieved by the following configuration of [4] relating to the welding method.

[4] A welding method using the welding system according to [3].

The above-described object of the present invention is achieved by the following configuration of [5] relating to the weaving control program.

[5] A weaving control program used in weaving control for welding a workpiece having a groove using a portable welding robot that moves on a guide rail, the weaving control program including:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, in which
the weaving control program executes a function of synchronizing an instruction of a stop signal and an instruction of a departure signal to be given immediately after instructing the stop signal or after the lapse of a predetermined stop time under the speed condition of each of the plurality of direction components calculated in the speed condition calculation step with each other at least when a weaving end is reached.

### Advantageous Effects of Invention

According to the present invention, it is possible to provide a weaving control method, a welding control device, a welding system, a welding method, and a weaving control program for obtaining an excellent weld quality of various kinds of position welding such as flat welding, horizontal welding, and vertical welding using a portable welding robot that moves on a guide rail.

### BRIEF DESCRIPTION OF DRAWINGS

FIG. 1 is a schematic diagram illustrating one embodiment of a welding system according to the present invention.

FIG. 2 is a schematic side view illustrating a portable welding robot illustrated in FIG. 1.

FIG. 3 is a perspective view illustrating the portable welding robot illustrated in FIG. 2.

FIG. 4 is an enlarged view illustrating an approximate linear movement mechanism illustrated in FIG. 2.

FIG. 5 is a graph illustrating a reference speed setting waveform.

FIG. 6 is a schematic perspective view illustrating a groove portion of a workpiece.

FIG. 7 is a schematic perspective view illustrating a portable welding robot to which a linear guide rail is applied for a groove including a curve.

FIG. 8 is a time chart illustrating a welding speed between weld line position detection points.

FIG. 9 is a perspective view schematically illustrating a weaving pattern in flat welding.

FIG. 10 illustrates a time chart of a weaving speed in Section (a), and a time chart of a welding speed in Section (b).

FIG. 11 is a graph illustrating a weaving pattern in the time chart illustrated in FIG. 10.

FIG. 12 is a time chart of weaving where a stop time is set at both ends.

FIG. 13 is a graph illustrating a weaving pattern in the time chart illustrated in FIG. 12.

FIG. 14A is a perspective view illustrating a weaving pattern accompanied by movement in three X, Y, and Z axis directions.

FIG. 14B is an A arrow diagram in FIG. 14A.

FIG. 15 is a time chart of weaving accompanied by movement in three X, Y, and Z axis directions.

FIG. 16 is a graph illustrating a weaving pattern in the time chart illustrated in FIG. 15.

FIG. 17 is a schematic diagram illustrating a weaving pattern in horizontal welding.

FIG. 18 illustrates a time chart of a weaving speed for implementing the weaving pattern illustrated in FIG. 17 in Section (a), and a time chart of a welding speed for implementing the weaving pattern illustrated in FIG. 17 in Section (b).

FIG. 19 is a schematic diagram illustrating a weaving pattern in a serrated shape.

FIG. 20 illustrates a time chart of a weaving speed for implementing the serrated weaving pattern illustrated in FIG. 19 in Section (a), and a time chart of a welding speed for implementing the serrated weaving pattern illustrated in FIG. 19 in Section (b).

FIG. 21 is a graph illustrating the serrated weaving pattern.

FIG. 22 is a perspective view illustrating vertical welding.

FIG. 23A is a B arrow diagram illustrating an example of the weaving pattern in vertical welding illustrated in FIG. 22, FIG. 23B is a B arrow diagram of another example, and FIG. 23C is a B arrow diagram of still another example.

FIG. 24 is a time chart collectively illustrating a weaving pattern accompanied by movement in three X, Y, and Z axis directions and a welding speed and a weaving speed in each of the directions.

FIG. 25 is a schematic diagram illustrating a state in which both groove ends are welded using a combination of an XA direction movement of a welding torch by an X-axis movement mechanism and an XB direction movement of the welding torch by a welding torch rotation driving portion.

FIG. 26 is a schematic diagram illustrating a state in which a torch angle changes without moving a welding wire tip position of the welding torch using the combination of the XA direction movement of the welding torch by the X-axis movement mechanism and the XB direction movement of the welding torch by the welding torch rotation driving portion.

FIG. 27 is a time chart for changing the torch angle illustrated in FIG. 26.

FIG. 28A is a diagram illustrating weaving when a welding speed and a weaving cycle are appropriate, and FIG. 28B is a diagram illustrating weaving when a welding speed is excessive.

FIG. 29 is a diagram illustrating weaving when a welding torch is stopped at one end and a welding speed is excessive.

### DESCRIPTION OF EMBODIMENTS

Hereinafter, a welding system according to one embodiment of the present invention will be described with reference to the drawings. The present embodiment is one example where a portable welding robot is used, and a welding system according to the present invention is not limited to the configuration of the present embodiment.

### <Configuration of Welding System>

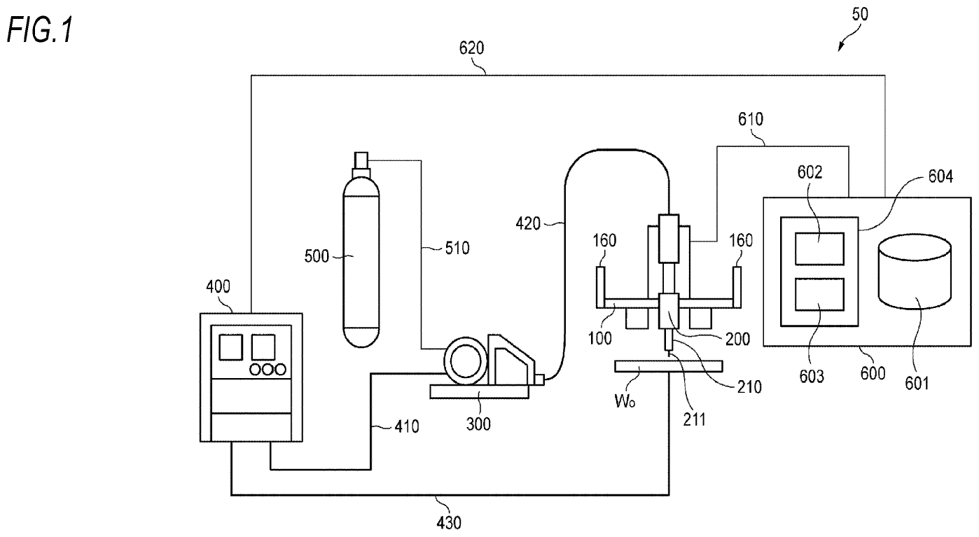

FIG. 1 is a schematic diagram illustrating a configuration of the welding system according to the present embodiment. As illustrated in FIG. 1, a welding system 50 includes a portable welding robot 100, a feeding device 300, a welding power supply 400, a shielding gas supply source 500, and a control device 600.

### [Control Device]

The control device 600 is connected to the portable welding robot 100 through a robot control cable 610, and is connected to the welding power supply 400 through a power control cable 620. The control device 600 includes a data storage unit 601 that stores teaching data in which an operation pattern, a welding start position, a welding end position, welding conditions, weaving, and the like of the portable welding robot 100 are predetermined, transmits instructions to the portable welding robot 100 and the welding power supply 400 based on the teaching data, and controls an operation and welding conditions of the portable welding robot 100.

The control device 600 includes a groove shape information calculation unit 602 that calculates groove shape information from detection data acquired by, for example, sensing described below, and a welding condition acquisition unit 603 that corrects and acquires the welding conditions of the teaching data based on the groove shape information. A control unit 604 is configured by the groove shape information calculation unit 602 and the welding condition acquisition unit 603.

The control device 600 is formed such that a controller for performing teaching, a manual operation of the portable welding robot 100, or the like and a controller that has other control functions are integrated. Note that the control device 600 is not limited thereto, and may be divided by function into a plurality of controllers, for example, into two controllers including a controller for performing teaching and a controller having other control functions, or the portable welding robot 100 may include the control device 600. In the present embodiment, signals are transmitted using the robot control cable 610 and the power control cable 620. However, the present invention is not limited thereto, and a signal may be transmitted wirelessly. From the viewpoint of usability in a welding site, it is preferable that the control device 600 is divided into two controllers including a controller for performing teaching, a manual operation of the portable welding robot 100, or the like and a controller that has other control functions.

### [Welding Power Supply]

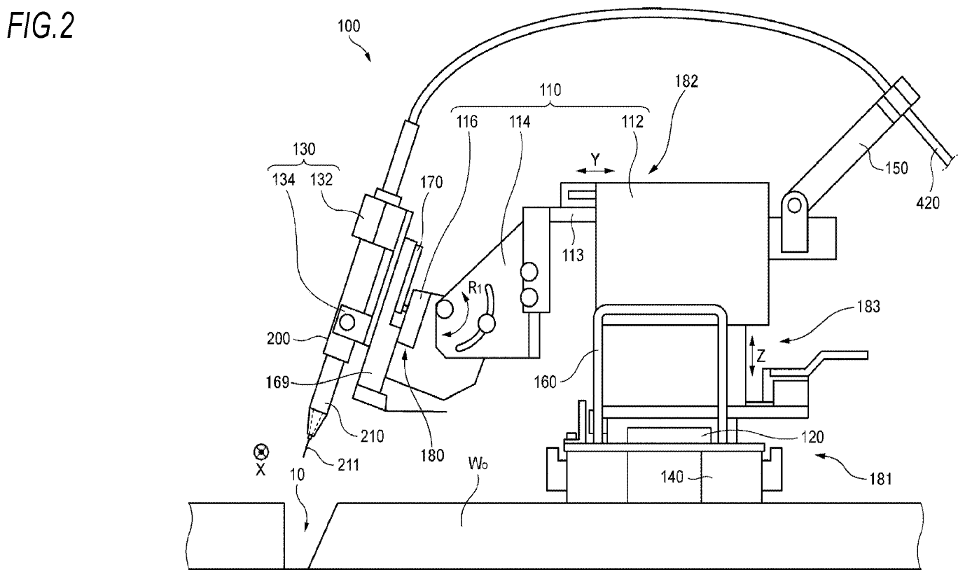

The welding power supply 400 supplies electric power to a welding wire 211 and a workpiece Wₒ as a consumable electrode to generate arc between the welding wire 211 and the workpiece Wₒ in response to an instruction from the control device 600. Electric power from the welding power supply 400 is transmitted to the feeding device 300 through a power cable 410, and is transmitted from the feeding device 300 to a welding torch 200 through a conduit tube 420. As illustrated in FIG. 2, electric power from the welding power supply 400 is supplied to the welding wire 211 through a contact tip at a tip of the welding torch 200. A current during welding work may be a direct current or an alternating current, and a waveform thereof is not particularly limited. Accordingly, the current may be a pulse such as a rectangular wave or a triangular wave.

In the welding power supply 400, for example, the power cable 410 is connected to the welding torch 200 side as a positive electrode, and a power cable 430 is connected to the workpiece Wₒ as a negative electrode. Here, welding with reverse polarity is performed. When welding with straight polarity is performed, the power cable of the positive electrode may be connected to the workpiece Wₒ, and the power cable of the negative electrode may be connected to the welding torch 200 side.

### [Shielding Gas Supply Source]

The shielding gas supply source 500 is configured by a container in which shielding gas is sealed and an additional member such as a valve. The shielding gas is transmitted from the shielding gas supply source 500 to the feeding device 300 through a gas tube 510. The shielding gas is transmitted from the feeding device 300 to the welding torch 200 through the conduit tube 420. The shielding gas transmitted to the welding torch 200 flows in the welding torch 200, is guided to a nozzle 210, and is ejected from the tip side of the welding torch 200. As the shielding gas used in the present embodiment, for example, argon (Ar), carbon dioxide gas (CO₂), or mixed gas thereof can be used.

### [Feeding Device]

The feeding device 300 unwinds the welding wire 211 and feeds the welding wire 211 to the welding torch 200. The welding wire 211 fed by the feeding device 300 is not particularly limited, and is selected depending on properties, welding configurations, and the like of the workpiece Wₒ. For example, a solid wire or a flux cored wire is used. A material of the welding wire is not also particularly limited and may be, for example, mild steel, stainless steel, aluminum, or titanium. A wire diameter of the welding wire is not particularly limited. In the present embodiment, an upper limit of the wire diameter is preferably 1.6 mm, and a lower limit of the wire diameter is preferably 0.9 mm.

In the conduit tube 420 according to the present embodiment, a conductive path for functioning as a power cable is formed on an outer skin side of the tube, a protective tube that protects the welding wire 211 is disposed in the tube, and a flow path of the shielding gas is formed. Note that the conduit tube 420 is not limited thereto. For example, a bundle in which a power supply cable or a shielding gas supply hose is bundled around the protective tube for feeding the welding wire 211 to the welding torch 200 can also be used. For example, the tube for feeding the welding wire 211 and the shielding gas and the power cable can also be individually provided.

### [Portable Welding Robot]

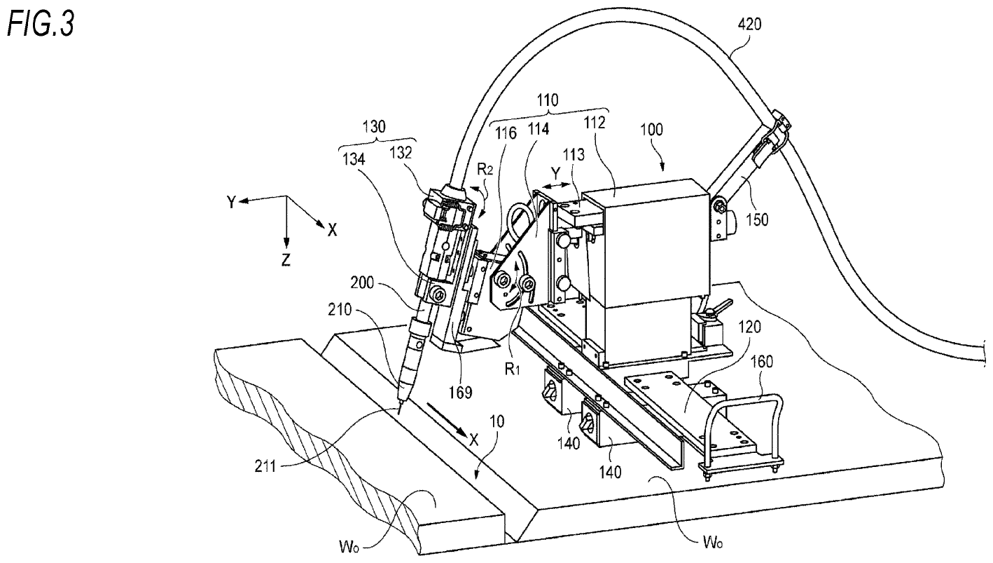

As illustrated in FIGS. 2 and 3, the portable welding robot 100 includes a guide rail 120, a robot body 110 that is provided on the guide rail 120 and moves along the guide rail 120, and a torch connection portion 130 that is placed on the robot body 110. The robot body 110 is mainly configured by a body portion 112 that is provided on the guide rail 120, a fixed arm portion 114 that is attached to the body portion 112, and a welding torch rotation driving portion 116 that is attached to the fixed arm portion 114 to be rotatable in an arrow R₁ direction.

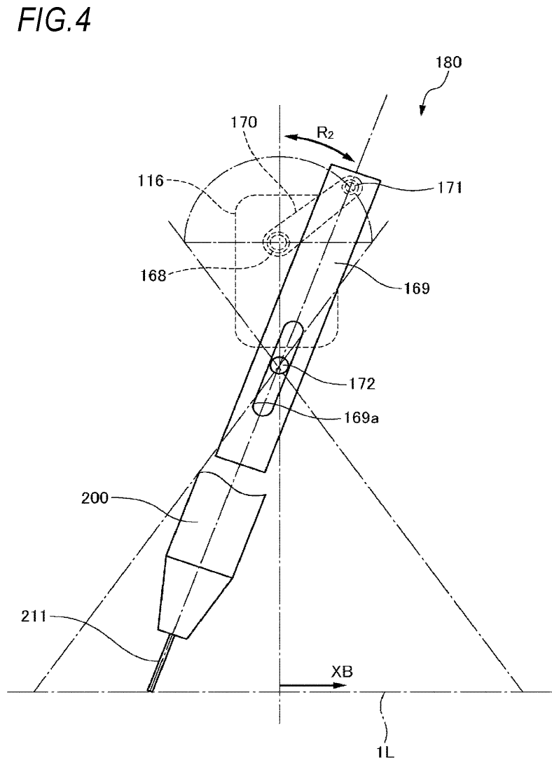

As illustrated in FIG. 4, the torch connection portion 130 is attached to the welding torch rotation driving portion 116 through a sliding table 169 and a crank 170. The torch connection portion 130 includes a torch clamp 132 and a torch clamp 134 that fix the welding torch 200. On a side of the body portion 112 opposite to the side where the welding torch 200 is mounted, a cable clamp 150 that supports the conduit tube 420 connecting the feeding device 300 and the welding torch 200 is provided.

In the present embodiment, a voltage is applied between the workpiece Wₒ and the welding wire 211, and a touch sensor that senses a surface of a groove 10 or the like using a voltage drop phenomenon occurring when the welding wire 211 comes into contact with the workpiece Wo is used as detection means. The detection means is not limited to the touch sensor of the present embodiment, and an image sensor, a laser sensor, or the like or a combination of such detection means may be used. For convenience of the device configuration, the touch sensor of the present embodiment is preferably used.

As indicated by an arrow X in FIG. 2, the body portion 112 of the robot body 110 includes an X-axis movement mechanism 181 that moves the robot body 110 along the guide rail 120 in an X-axis direction that is a weld line direction as a direction perpendicular to the paper plane. The body portion 112 includes a Y-axis movement mechanism 182 that moves the fixed arm portion 114 with respect to the body portion 112 through a slide support portion 113 in a Y-axis direction that is a width direction of the groove 10 perpendicular to the X-axis direction and a Z-axis direction. The body portion 112 includes a Z-axis movement mechanism 183 that moves the robot body 110 in a depth direction of the groove 10 perpendicular to the X-axis direction.

As illustrated in FIG. 4, the sliding table 169, the crank 170, and the welding torch rotation driving portion 116 to which the torch connection portion 130 is attached configure an approximate linear movement mechanism 180 that moves the tip of the welding wire 211 along an approximate straight line.

Specifically, the crank 170 is fixed to a rotating shaft 168 of a motor (not illustrated) fixed to the welding torch rotation driving portion 116, and a tip of the crank 170 is connected to one end of the sliding table 169 through a connecting pin 171. The sliding table 169 includes a long groove 169a in an intermediate portion, and a fixing pin 172 fixed to the welding torch rotation driving portion 116 is slidably fitted into the long groove 169a.

As a result, when the crank 170 rotates around the rotating shaft 168 using the motor (not illustrated), the sliding table 169 rotates using the fixing pin 172 as a supporting point, is guided to the fixing pin 172 for fitting, and moves along the long groove 169a. That is, in the torch connection portion 130 to which the welding torch 200 is attached, the crank 170 rotates as indicated by an arrow R₂ illustrated in FIGS. 3 and 4 such that the tip of the welding wire 211 is driven in the X-axis direction along an approximate straight line indicated by an imaginary line IL in FIG. 4 while tilting the welding torch 200. As the mechanism that moves in the X-axis direction in the present embodiment, the X-axis movement mechanism 181 and the approximate linear movement mechanism 180 described above are provided. Hereinafter, when such mechanisms are distinguished from each other for description, a direction of movement in the X-axis direction by the X-axis movement mechanism 181 will be referred to as “XA-axis direction”, and a direction of movement in the X-axis direction by the approximate linear movement mechanism 180 will be referred to as “XB-axis direction”. When the mechanisms do not need to be distinguished, a direction of movement will be simply referred to as “X-axis direction” for description.

As indicated by an arrow R₁ in FIG. 2, the welding torch rotation driving portion 116 is rotatably attached to the fixed arm portion 114, and can be adjusted and fixed to an optimum angle.

As described above, in the robot body 110, the welding torch 200 at the tip portion can be driven with four degrees of freedom in the three directions, that is, in the X-axis direction, the Y-axis direction, and the Z-axis direction by the approximate linear movement mechanism 180, the X-axis movement mechanism 181, the Y-axis movement mechanism 182, and the Z-axis movement mechanism 183. Note that the robot body 110 is not limited thereto and can be driven with any number of degrees of freedom depending on uses.

With the above-described configuration, the tip portion of the welding wire 211 of the welding torch 200 attached to the torch connection portion 130 can be directed to any direction. That is, the robot body 110 can be driven on the guide rail 120 in the X-axis direction. The welding torch 200 can be driven in the Y-axis direction that is the width direction of the groove 10 or in the Z-axis direction that is the depth direction of the groove 10. With the driving by the crank 170, the welding torch 200 can be tilted depending on, for example, a construction condition such as providing a push angle or drag angle.

Below the guide rail 120, for example, an attachment member 140 such as a magnet is provided, and the guide rail 120 is configured to be easily attached to and detached from the workpiece Wₒ by the attachment member 140. When the portable welding robot 100 is set in the workpiece Wₒ, an operator grips both handles 160 of the portable welding robot 100 such that the portable welding robot 100 can be easily set on the workpiece Wₒ.

### <Movement Speed Setting Method of Each Drive Shaft of Portable Welding Robot>

A stepping motor is used in each of drive shafts of the X-axis movement mechanism 181, the Y-axis movement mechanism 182, the Z-axis movement mechanism 183, and the approximate linear movement mechanism 180 that move the welding torch 200 of the portable welding robot 100 in any direction of the X-axis direction, the Y-axis direction, and the Z-axis direction. A rotating shaft of the stepping motor is coupled to a reducer, and a pinion is attached to a rotating shaft of the reducer in the movement mechanisms in the X-axis direction, the Y-axis direction, and the Z-axis direction.

In the XA-axis direction, the welding torch 200 is driven in the XA-axis direction while meshing with a rack attached to the guide rail 120. In the Y-axis direction, the welding torch 200 is driven in the Y-axis direction while meshing with a rack attached to the slide support portion 113. Likewise, even in the Z-axis direction, the welding torch 200 is driven in the Z-axis direction while meshing with a rack attached to a slide support portion in the Z-axis direction provided in the portable welding robot 100.

In the XB-axis direction, the crank 170 is attached to the rotating shaft 168 of the reducer of the welding torch rotation driving portion 116, and by rotating the crank 170, the tip of the welding wire 211 can be moved in the XB-axis direction while tilting the welding torch 200. The welding torch rotation driving portion 116 can set a torch angle of the welding torch 200, and can set a movement speed or a movement distance by which the tip of the welding wire 211 moves in the XB-axis direction.

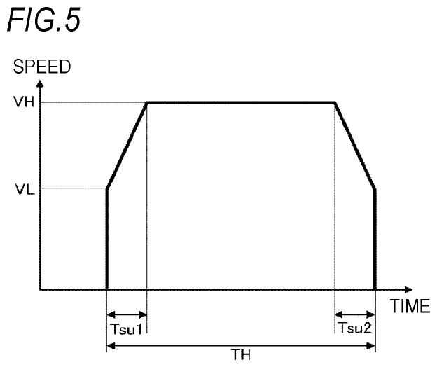

In the process of the movement speed from departure to stop in the X-axis direction, the Y-axis direction, and the Z-axis direction, speed setting is performed along with acceleration and deceleration of a speed having a waveform illustrated in FIG. 5 based on characteristics of the stepping motor. A set speed VH is set to an original movement speed, and an acceleration time Tsu1 and a deceleration time Tsu2 are set around the set speed VH. On the departure side, the movement speed increases from an initial speed VL as a first speed set value to the set speed VH as a second speed set value. On the stop side, the movement speed decreases from the set speed VH to the initial speed VL and stops. A movement time TH from departure to stop includes the acceleration time Tsu1, the deceleration time Tsu2, and a period of movement at the set speed VH therebetween. The acceleration time Tsu1 and the deceleration time Tsu2 vary depending on a load or a set speed of each of the axes and are substantially several tens of milliseconds to several hundreds of milliseconds. The reason for providing the initial speed VL that is slower than the set speed VH is that, when the movement speed increases directly from the stop state to the set speed VH, the stepping motor may be stepped out without following the movement speed.

When a molten pool for forming a weld bead is present immediately below arc as a heat source, a stable state is maintained, and an excellent weld bead can be formed. If the set speed VH exceeds the initial speed VL, when the welding speed, that is, the movement speed of the arc is rapidly changed to the set speed, the arc as a heat source moves at once before base metal sufficiently melts. Therefore, the melting of the base metal is insufficient, the molten pool cannot be present immediately below the arc, the welding speed changes at once, and an irregular weld bead is formed accordingly. To avoid such problem, when the movement speed of the arc is caused to reach the set speed VH, by gradually increasing the movement speed of the arc in a slope shape from the initial speed VL to the set speed VH, the formation of the molten pool also follows the movement of the arc, and the molten pool is caused to be present immediately below the arc.

Accordingly, when the set speed VH is the initial speed VL or slower, the acceleration time Tsu1 and the deceleration time Tsu2 are not necessary, and FIG. 5 illustrates a rectangular shape starting from the set speed VH. By using the waveform illustrated in FIG. 5 as one unit and repeating the units, the welding torch 200 moves in each of the directions. That is, when the setting of FIG. 5 is repeated, instructions of a stop signal and a departure signal are transmitted in synchronization with each other, and the welding torch 200 is moved in the X-axis direction, the Y-axis direction, and the Z-axis direction while repeating departure and stop. A slope of a speed change from the initial speed VL to the set speed VH and a slope of a speed change from the set speed VH to the initial speed VL, that is, accelerations thereof are preferably fixed values in a range where there is no concern of the above-described step-out, and the acceleration time Tsu1 and the deceleration time Tsu2 may be determined based on predetermined slopes.

### [Acquisition of Welding Condition of Weld Line Position Detection Point Pₙ]

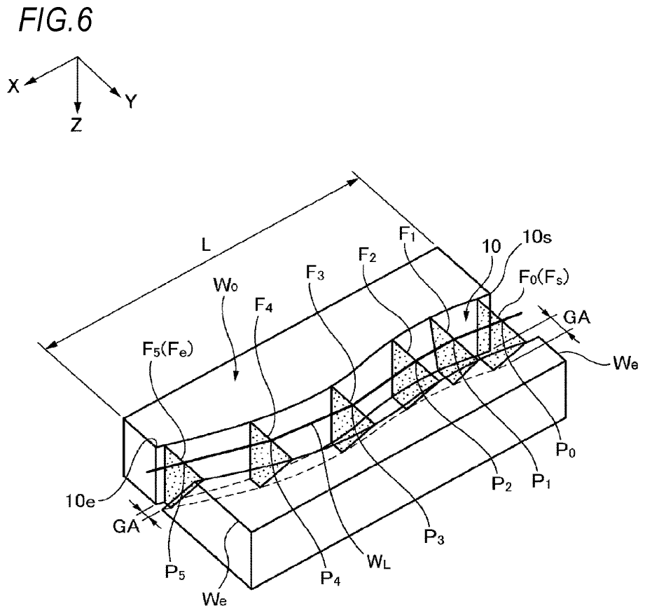

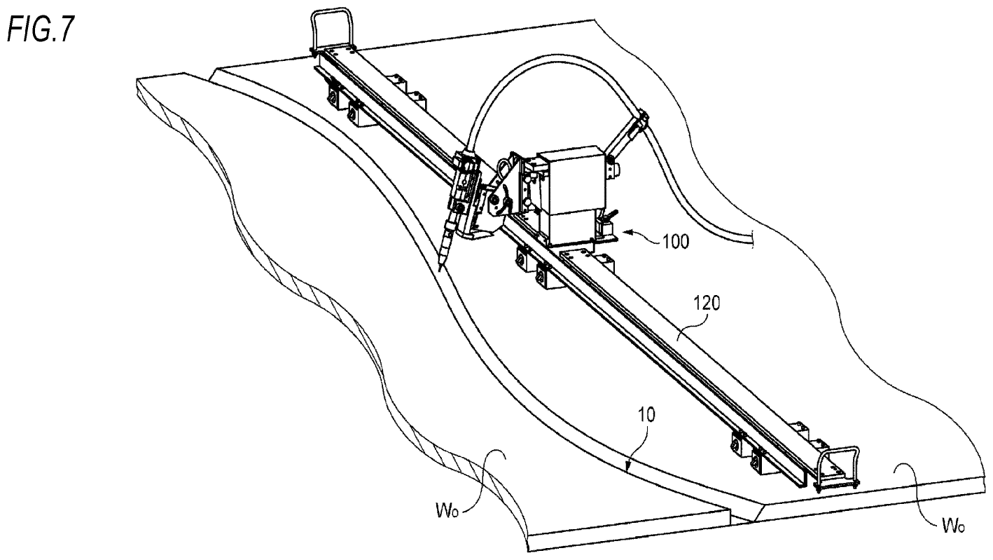

FIG. 6 is a perspective view illustrating a groove portion of the workpiece Wₒ, and is a schematic perspective view when the weld line direction that is a longitudinal direction of the groove 10 includes not only a straight line but also a curve and the groove 10 where a root gap GA in the width direction of the groove 10 changes is welded. FIG. 7 is a schematic perspective view when the portable welding robot 100 is provided in the linear guide rail 120 for the groove 10 that also includes a curve as in FIG. 6.

When the groove 10 is welded, a teaching program where an operation and welding conditions of the portable welding robot 100 are set is generated in advance, and welding conditions for welding are corrected and acquired using the portable welding robot 100 that moves along the guide rail 120 before the start of welding. Specifically, for example, based on an operation signal of the control device 600, the portable welding robot 100 is driven to start automatic sensing of a groove shape, groove shape information is calculated, welding conditions are calculated, and automatic gas shielded arc welding is performed.

That is, in a setting step when the teaching program is generated or corrected, after setting at least a condition of a weaving reference trajectory described below, groove shape information is calculated. A stage of calculating welding conditions includes at least a speed condition calculation step during the calculation of the welding conditions. In the speed condition calculation step, a speed condition for giving an instruction to each of the movement mechanisms 180, 181, 182, and 183 is calculated for each of a plurality of direction components to perform automatic gas shielded arc welding.

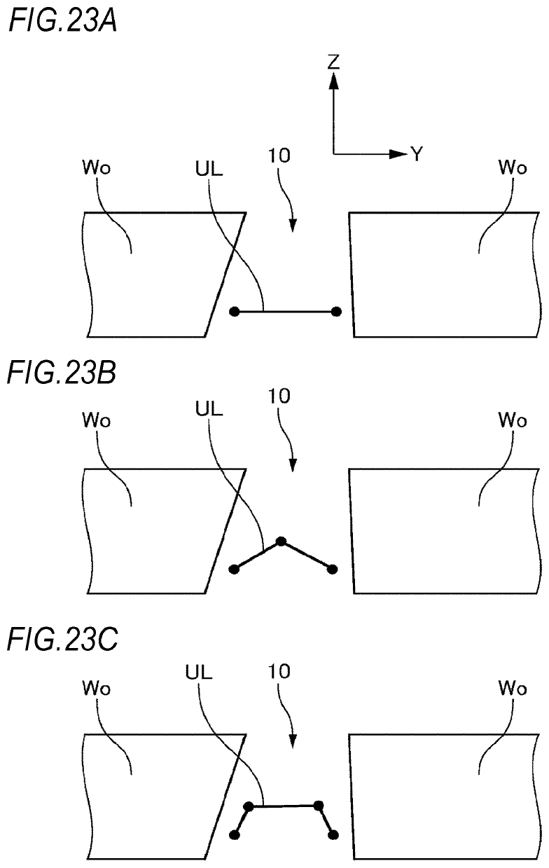

Here, in the present embodiment, “the condition of the weaving reference trajectory” set in the setting step is a condition relating to a reference distance for determining a weaving pattern, and includes at least two pieces of information among a reference distance in the X-axis direction, a reference distance in the Y-axis direction, and a reference distance in the Z-axis direction in the present embodiment. More specifically, as in the drawing illustrated on the left side of FIG. 24, for example, a pitch Pt described below is used as an item representing the reference distance in the X-axis direction, a weaving width YO of the Y-axis is used as an item representing the reference distance in the Y-axis direction, and a weaving width ZO of the Z-axis is used as an item representing the reference distance in the Z-axis direction. In the present embodiment, the pitch Pt and the weaving width ZO are set in advance, and a set value of the weaving width YO changes based on a gap width calculated in a groove shape information calculation step described below.

Examples of the condition set in the setting step include not only the condition of the weaving reference trajectory but also a condition of a stop time of a weaving end, a condition of a speed ratio G between outward and return paths in weaving, and a condition of a shift amount in which any position is shifted in any direction described below. As the condition of the stop time of the weaving end, a set value may be provided depending on a position at which a welding torch is stopped at a weaving end. For example, it is preferable that a stop time T1 of one weaving end and a stop time T2 of another weaving end can be dividedly set.

The details of the condition of the shift amount in which any position is shifted in any direction will be described below. As in the drawing illustrated on the left side of FIG. 24, in the present embodiment, a distance XO in which a position of an upper weaving end YO of the paper plane is shifted in the X-axis direction is set as the shift amount. When a weaving pattern determined by the condition of the weaving reference trajectory, that is, a trajectory indicated by a solid line in the drawing illustrated on the left side of FIG. 24 is set as a standard weaving pattern for convenience of description, when the position of the upper weaving end of the paper plane is shifted from the standard weaving pattern in the X-axis direction by a distance corresponding to a numerical value set as the shift amount XO, a special weaving pattern having a serrated shape can be applied as in a trajectory indicated by a dotted line in the drawing. The shift amount XO may be set to a fixed value in advance, or a set value thereof may change every time based on a gap variation before welding or during welding.

Regarding the sensing, a groove shape, a sheet thickness, starting and terminal ends, and the like are sensed by the above-described touch sensor in a sensing step.

In the sensing step, for example, as illustrated in FIG. 6, in a welding section from a welding start point 10s to a welding end point 10e of the groove 10, the groove includes not only a straight line but also a curve, and when the root gap GA also changes such that the groove shape varies depending on locations, in a cross-sectional shape of the groove 10 having an inverted trapezoidal shape, a plurality of positions, in the present embodiment, six positions are provided as a groove shape detection position Fₙ (F₀, F₂, . . . , F₅) for sensing.

In the present embodiment, an intersection point between the groove shape detection position Fₙ and a weld line WL is set as the weld line position detection points Pₙ (P₀ to P₅). The weld line WL refers to a movement trajectory of the tip of the welding wire 211 set at any position in the groove 10 of the workpiece Wₒ, and the tip of the welding torch 200 is weaved along the weld line WL, that is, the X-axis direction, in the groove width direction, that is, in the Y-axis direction.

Specifically, by setting the groove shape detection position Fₙ closest to the welding start point 10s as a first groove shape detection position Fₛ (F₀) and setting the groove shape detection position Fₙ closest to the welding end point 10e as a second groove shape detection position Fₑ (F₅), sensing is performed by the touch sensor while the portable welding robot 100 is moving on the guide rail 120. The position settings of the first groove shape detection position Fₛ and the second groove shape detection position Fₑ may be input to the control device 600 in advance by teaching or the like.

From detection data of the groove cross-sectional shape at each of the groove shape detection positions Fₙ (F₀ to F₅) obtained in the sensing step, a groove angle of the groove shape, the sheet thickness, the root gap GA, a distance L between workpiece end portions Wₑ, and the like are calculated after the sensing step. Hereinafter, the calculation steps will be referred to as “groove shape information calculation step”. Based on the groove shape calculated in each of the groove shape detection positions Fₙ (F₀ to F₅), welding conditions of each of the weld line detection points Pₙ (P₀ to P₅) in the weld line WI, are calculated, and welding conditions for actual welding are determined through a welding condition calculation step of correcting the welding conditions acquired or set in advance in the control device 600. When weld beads are deposited under the welding conditions of each of the weld line detection points Pₙ (P₀ to P₅) acquired herein, the numbers of depositions of weld beads and the numbers of passes in the groove are the same. Examples of the welding conditions of each of the weld line detection points Pₙ (P₀ to P₅) include a welding current, a welding voltage, a welding speed, a target position of a welding wire tip of the welding torch, a weaving width, and the like for each pass.

### [Control Method of Movement Speed (Welding Speed) in X-Axis Direction in Weaving Between Weld Line Position Detection Points Pₙ]

Next, a control method of a welding speed between the weld line position detection points Pₙ using the welding system 50 according to the present embodiment will be described in detail.

The welding speed of the weld line position detection point Pₙ is obtained in the above-described welding condition calculation step, and a welding speed between adjacent weld line position detection points (Pₙ₋₁, Pₙ) is determined to complement the welding speeds at the adjacent weld line position detection points (Pₙ₋₁, Pₙ) by being dividedly changed in stages with respect to the pitch Pt that is one element relating to the reference distance for determining the weaving pattern in a movement distance DXₙ in the X-axis direction between the adjacent weld line position detection points (Pₙ₋₁, Pₙ). The details will be described below.

As illustrated in FIG. 3, the guide rail 120 is disposed along the groove 10 to be welded. Therefore, assuming that the groove 10 is disposed along the X-axis direction, the welding speed and the movement speed in the X-axis direction are the same. That is, the welding speed between the adjacent weld line position detection points (Pₙ₋₁, Pₙ) is the same as the movement speed in the X-axis direction between the weld line position detection points (Pₙ₋₁, Pₙ). Based on such definition, the following calculation is performed.

First, the movement distance DXₙ in the X-axis direction between the adjacent weld line position detection points (Pₙ₋₁, Pₙ) is divided by a temporary pitch Pt′ that is set in advance to obtain a temporary number m′ of divisions as represented by Expression (1).

$$\begin{matrix}[ Numeral 1 ] & \\ {m}^{′} = \frac{{DX}_{n}}{{Pt}^{′}} & ( 1 )\end{matrix}$$

Next, an integer obtained by rounding down the temporary number m′ of divisions to the nearest whole number is obtained as a final number m of divisions, and ΔD is obtained from Expression (2).

$$\begin{matrix}[ Numeral 2 ] & \\ Δ D = \frac{{DX}_{n} - m \cdot {Pt}^{′}}{m} & ( 2 )\end{matrix}$$

A final pitch Pt is obtained from Expression (3).

$$\begin{matrix}[ Numeral 3 ] & \\ P t = {Pt}^{′} + Δ D & ( 3 )\end{matrix}$$

The calculation herein represents that the movement distance DXₙ in the X-axis direction between the weld line position detection points (Pₙ₋₁, Pₙ) can be divided by the pitch Pt into m number of divisions of integers without fractions. The pitch Pt and the number m of divisions are units for determining the weaving condition as described below.

Next, a welding speed VXₖ of a portion divided for each of the pitches Pt that is, a movement speed in the X-axis direction is obtained.

As represented by Expression (4), a difference between the welding speeds (VXPₙ₋₁, VXPₙ) calculated at the weld line position detection points (Pₙ₋₁, Pₙ) is divided by the number m of divisions to obtain a welding speed ΔVX that is an increase or decrease for each of the pitches Pt.

$$\begin{matrix}[ Numeral 4 ] & \\ Δ VX = \frac{{VXP}_{n} - {VXP}_{n - 1}}{m} & ( 4 )\end{matrix}$$

Using Expression (4), a welding speed for each of the pitches Pt is obtained as represented by Expression (5).

$$\begin{matrix}[ Numeral 5 ] & \\ {VX}_{k} = {VXP}_{n - 1} + k \cdot Δ VX & ( 5 )\end{matrix}$$

Here, k represents an integer of 1 to m, and VXₘ=VXPₙ is satisfied from Expression (4) and Expression (5).

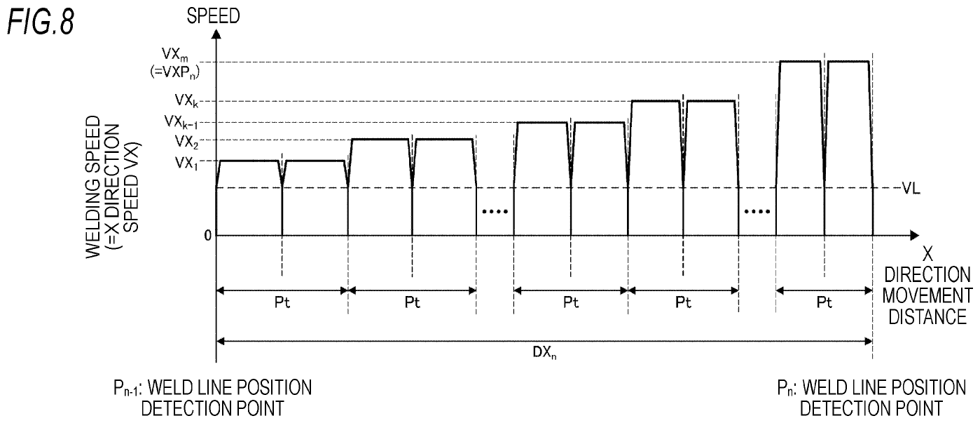

The welding speed VXₖ for each of the pitches Pt is obtained from Expression (5). Since ½ of the pitch Pt is positioned at a weaving end when weaving as described below, the welding speed VXₖ is set to be stopped at the end. The setting is to determine weaving conditions described below. FIG. 8 illustrates the control of the welding speed VX between the weld line position detection points (Pₙ₋₁, Pₙ) obtained as described above. The welding speed VX represents that the movement speed in the X-axis direction, that is, the welding speed is controlled in units of the trapezoidal speed setting described above with reference to FIG. 5.

That is, the welding speed VX between the weld line position detection points (Pₙ₋₁, Pₙ) is changed in stages by ΔVX with reference to the pitch Pt in the movement distance DXₙ in the X-axis direction such that departure and stop are repeated at intervals of ½ of the pitch Pt. In FIG. 6 of the present embodiment, by obtaining the welding speeds VX between adjacent weld line position detection points (P₀, P₁), (P₁, P₂), (P₂, P₃), (P₃, P₄), and (P₄, P₅) as illustrated in FIG. 8, the welding speed VX is determined over the entire length of the groove 10. The pitch Pt is a value that affects a reciprocating cycle of weaving described below and, in the present embodiment, is set in a range of the pitch Pt=5 to 10 mm that is appropriate for filling a cross-section of the groove 10 as a target for weaving with weld metal.

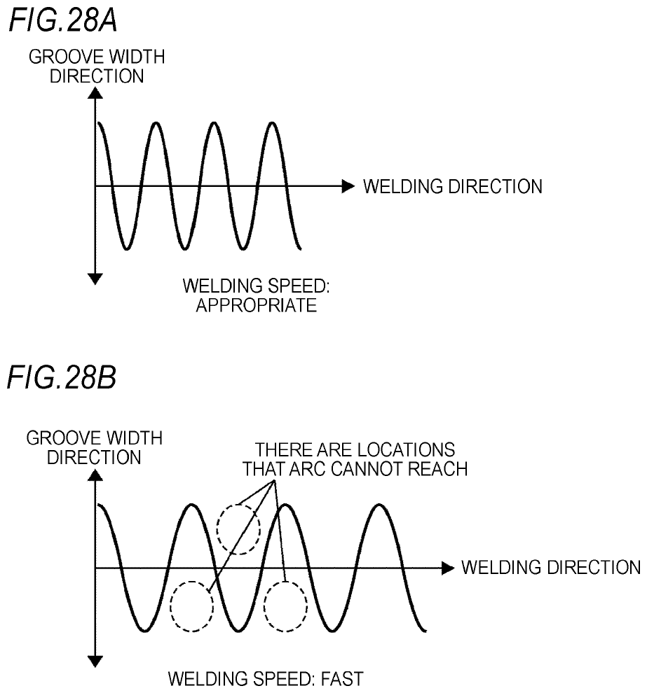

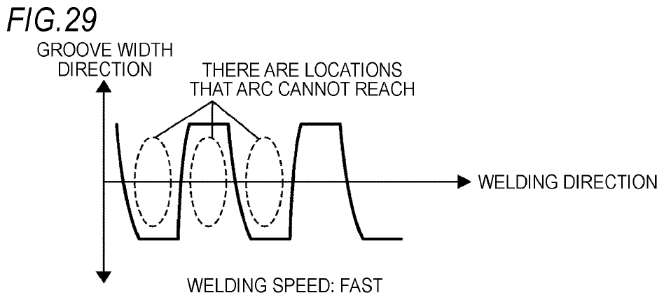

For example, in Patent Literature 3, the welding speed is determined by linear interpolation using the welding speed between two points of a groove, and the welding speed is continuous between the two points of the groove. In addition to Patent Literature 3, in general, it is a common knowledge that the welding speed is fixed or continuously changes. In the present embodiment, depending on positions of weaving ends, departure and stop are repeated at intervals of ½ of the pitch Pt as described above. Such control is means for solving the problems illustrated in FIG. 28B or FIG. 29.

The welding speed VX during welding has an acceleration region of several tens of milliseconds to several hundreds of milliseconds for each ½ of the pitch Pt until the speed reaches the set speed VH. However, as described above, the acceleration does not affect the welding phenomenon, and does not cause a problem in weld quality.

### [Control Method of Weaving Pattern Between Weld Line Position Detection Points Pₙ]

In the control device 600, welding conditions of each of the weld line detection points Pₙ are calculated, and, for example, a target position or a weaving width is also determined. The act of weaving is to fill the cross-section of the groove 10 with weld metal by allowing the robot body 110 to move on the guide rail 120 in the X-axis direction while performing welding and swinging the welding torch in the Y-axis direction or the Z-axis direction. The item of the weaving width is an important element for weaving. Therefore, it is preferable to determine at least one weaving width in the Y-axis direction and the Z-axis direction for the purpose.

Next, a control method of a weaving pattern between the weld line position detection points Pₙ using the welding system 50 according to the present embodiment will be described in detail.

### <Basic Control Method>

First, a basic control method will be described using flat welding as an example. Here, a weaving end is positioned at the pitch Pt/2, and a control method of weaving accompanied by movement of the welding torch in two directions including the X-axis direction and the Y-axis direction will be described.

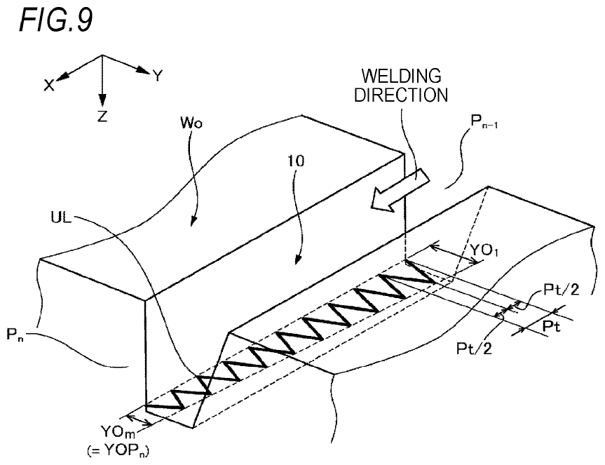

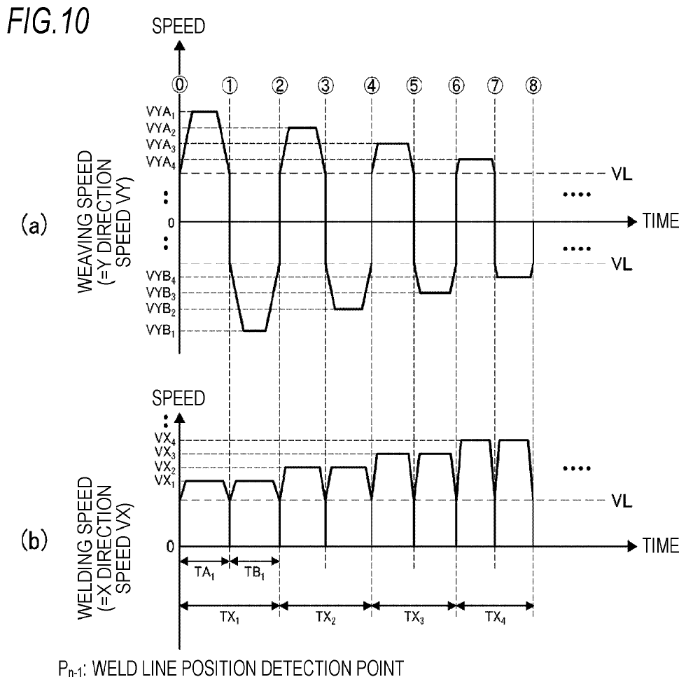

FIG. 9 schematically illustrates a weaving pattern UL in flat welding between the adjacent weld line position detection points (Pₙ₋₁, Pₙ). The welding torch reciprocates once in the groove 10 by the pitch Pt in the X-axis direction. That is, weaving is repeated, in which a path to one weaving end positioned at Pt/2 is an outward path and a path to another weaving end positioned at the next Pt/2 is a return path. Regarding the movement speed of weaving in the X-axis direction, the robot body 110 travels on the rail in the X-axis direction according to the setting of the welding speed VXₖ (k represents 1, 2, 3, 4, . . . m) illustrated in FIG. 10, and the movement speed in the Y-axis direction, that is, the weaving speed draws the weaving pattern UL of FIG. 9 according to the setting of the weaving speeds VYAₖ and VYBₖ (k represents 1, 2, 3, 4, . . . m) illustrated in FIG. 10.

Here, the weaving width is determined from Expression (7) below, and represents a movement of starting from a weaving width YO₁ at the start of the weld line position detection point Pₙ₋₁ illustrated in FIG. 9 and ending with a weaving width YOₘ (=YOPₙ) at the end of the weld line position detection point Pₙ. The movement is changed in stages by a weaving width increase or decrease AYO obtained by dividing a difference between the weaving widths (YOPₙ₋₁, YOPₙ) calculated at the weld line position detection points (Pₙ₋₁, Pₙ) by the number m of divisions, and is controlled to complement the weaving widths (YOPₙ₋₁, YOPₙ).

More details will be described. The weaving width increase or decrease AYO between the weaving widths (YOPₙ₋₁, YOPₙ) of the weld line position detection points (Pₙ₋₁, Pₙ) is represented by the following Expression (6).

$$\begin{matrix}[ Numeral 6 ] & \\ Δ YO = \frac{{YOP}_{n} - {YOP}_{n - 1}}{m} & ( 6 )\end{matrix}$$

Accordingly, the weaving width YO between the weld line position detection points (Pₙ₋₁, Pₙ) is represented by the following Expression (7).

$$\begin{matrix}[ Numeral 7 ] & \\ {YO}_{k} = {YOP}_{n - 1} + k \cdot Δ YO & ( 7 )\end{matrix}$$

Here, k represents an integer of 1 to m, and YOₘ=YOPₙ is satisfied from Expressions (6) and (7).

That is, Expression (7) represents that the region between the weld line position detection points (Pₙ₋₁, Pₙ) is divided by the number m of divisions and the weaving width YO is determined from Expression (7) in each of the divided regions. The number m of divisions is an integer using the setting of the welding speed VX.

In the present embodiment, in the region of the pitch Pt obtained by dividing any movement distance in the X-axis direction, that is, more specifically, the distance between the weld line position detection points (Pₙ₋₁, Pₙ) in the X-axis direction, by the number m of divisions, the welding speed VXₖ and the weaving speed VYₖ are synchronized to control the movement of the welding torch. A time TXₖ for which the welding torch moves in the X-axis direction by a distance corresponding to the pitch Pt is obtained from the following Expressions (8) to (10) using the welding speed VXₖ of Expression (5) set in the region.

$$\begin{matrix}[ Numeral 8 ] & \\ {TX}_{k} = \frac{P t}{{VX}_{k}} & ( 8 )\end{matrix}$$

$$\begin{matrix}[ Numeral 9 ] & \\ {TA}_{k} = \frac{{TX}_{k}}{2} & ( 9 )\end{matrix}$$

$$\begin{matrix}[ Numeral 10 ] & \\ {TB}_{k} = \frac{{TX}_{k}}{2} & ( 10 )\end{matrix}$$

Expressions (9) and (10) correspond to half of the time, that is, an outward path time and a return path time of weaving described below obtained by dividing the time into times for which the welding torch moves in the X-axis direction by ½ of the pitch Pt.

When speeds at which the welding torch moves in the X-axis direction by ½ of the pitch Pt, that is, a movement speed VXAₖ in the X-axis direction in the outward path and a movement speed VXBₖ in the X-axis direction in the return path are represented to correspond to Expressions (9) and (10), the following Expressions (11) and (12) are obtained.

$$\begin{matrix}[ Numeral 11 ] & \\ {VXA}_{k} = \frac{Pt / 2}{{TA}_{k}} & ( 11 )\end{matrix}$$

$$\begin{matrix}[ Numeral 12 ] & \\ {VXB}_{k} = \frac{Pt / 2}{{TB}_{k}} & ( 12 )\end{matrix}$$

On the other hand, the welding torch reciprocates once in the Y-axis direction by the weaving width YO. Here, the movement speed in the Y-axis direction, that is, the weaving speed can be dividedly represented by those in the outward path and the return path described above.

The time required for the weaving of the welding torch in the outward path is the same as the time for which the welding torch moves in the X-axis direction by ½ of the pitch Pt. The time required for the weaving of the welding torch in the return path is the same as the time for which the welding torch moves in the X-axis direction by ½ of the pitch Pt. The times are obtained from Expressions (9) and (10), respectively, and the weaving width YOK is obtained from Expression (7). Therefore, the weaving speed satisfies the following Expressions (13) and (14).

$$\begin{matrix}[ Numeral 13 ] & \\ {VYA}_{k} = \frac{{YO}_{k}}{{TA}_{k}} & ( 13 )\end{matrix}$$

$$\begin{matrix}[ Numeral 14 ] & \\ {VYB}_{k} = - 1 \cdot \frac{{YO}_{k}}{{TB}_{k}} & ( 14 )\end{matrix}$$

Expression (13) represents the weaving speed in the outward path, and Expression (14) represents the weaving speed in the return path by reversing the signs.

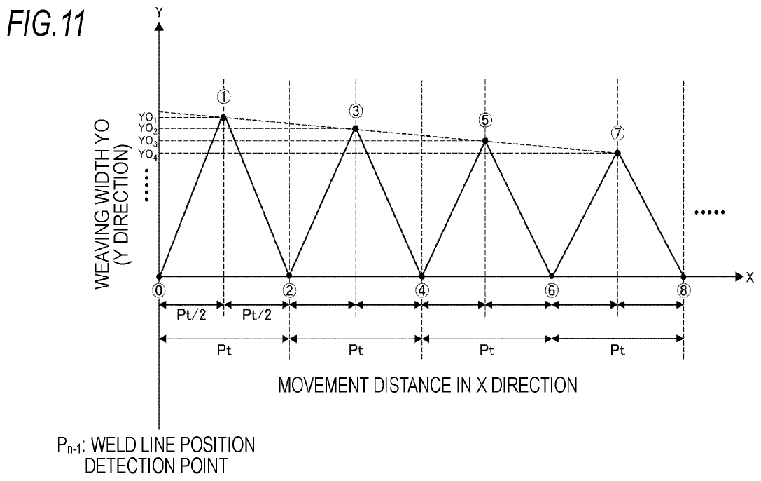

FIG. 10 illustrates a time chart of the weaving speed VY and the welding speed VX obtained from Expressions (5), (8), (9), (10), (11), (12), (13), and (14), and FIG. 11 illustrates a weaving pattern of the welding torch here.

As illustrated in FIG. 10, the combination of the welding speed VX and the weaving speed VY is controlled in units of the trapezoidal speed setting described above with reference to FIG. 5. At the time represented by circled figures 0 to 8 in the drawing, the welding speed VX and the weaving speed VY are simultaneously stopped at one end and simultaneously start moving. That is, departure and stop of the weaving speed VY is synchronized with departure and stop of the welding speed VX to be performed at the same timing such that the welding torch is weaved. FIG. 11 illustrates a trajectory of the weaving here. The positions of the welding torch at the time represented by the circled figures 0 to 8 in FIG. 10 are positions represented by the circled figures 0 to 8 in FIG. 11.

As can be seen from FIG. 11, the welding torch is weaved while repeating the movement in which the welding torch reciprocates once in the X-axis direction by the pitch Pt, that is, moves in the outward path by Pt/2 and moves in the return path by Pt/2. In other words, in the present embodiment, the weaving pattern is determined depending on the pitch Pt in the X-axis direction regardless of the welding speed VX.

As a result, the problem described above with reference to FIG. 28B is solved. That is, the concern of lack of penetration in the groove caused when the cycle of weaving is unintentionally widened due to the effect of the welding speed VX such that there are locations that the arc cannot reach during weaving is removed. In the present embodiment, weaving can be performed by reliably moving the welding torch to a target position along a target trajectory at a target time without depending on the welding speed VX. Therefore, the cross-section of the groove 10 can be efficiently filled with weld metal as the original purpose, and thus an excellent weld quality can be obtained.

### <Control Method of Both End Stop Time>

In weaving, a stop time at both weaving ends (hereinafter, the stop time at both weaving ends will be simply referred to as “stop time”) may be provided such that sufficient penetration of a groove wall can be obtained. Next, a control method of the stop at both ends according to the present embodiment will be described below using flat welding as an example.

In FIG. 11, a stop time at weaving upper end portions, that is, at circled figures 1, 3, 5, and 7 is represented by T1, and a stop time at weaving lower end portions, that is, at circled figures 2, 4, 6, and 8 is represented by T2. As described above, to achieve the object of the present invention, the time for which the welding torch moves in the X-axis direction by the pitch Pt needs to be always maintained regardless of the stop time at both weaving ends. The configuration is to maintain the welding speed of the weld line position detection points (Pₙ₋₁, Pₙ) obtained in the welding condition calculation step of the control device 600 without changing the welding time between the weld line position detection points (Pₙ₋₁, Pₙ) even when the stop time is provided or when weaving in the Z-axis direction described below is added. Therefore, a time TY for which the welding torch reciprocates once in the Y-axis direction by the weaving width YO when the stop time is provided at a weaving end portion is replaced with the following Expression (15) obtained by subtracting T1 and T2 from Expression (8).

$$\begin{matrix}[ Numeral 15 ] & \\ {TX}_{k} = \frac{Pt}{{VX}_{k}} - T 1 - T 2 & ( 15 )\end{matrix}$$

Here, k represents an integer of 1 to m. By providing the stop times T1 and T2, the welding speed VX needs to increase accordingly, and the welding speed VX is obtained using Expression (15) from Expressions (9), (10), (11), and (12).

On the other hand, the time TY for which the welding torch reciprocates once by the weaving width YO decreases, and the weaving speed moves faster accordingly. Here, the weaving speed VY is also obtained from Expressions (9), (10), (13), and (14) using Expression (15).

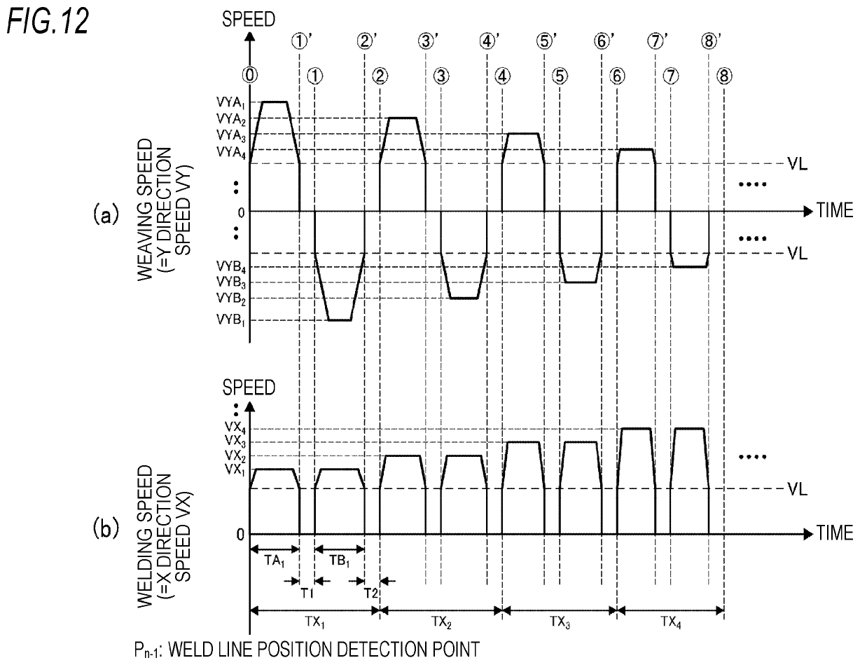

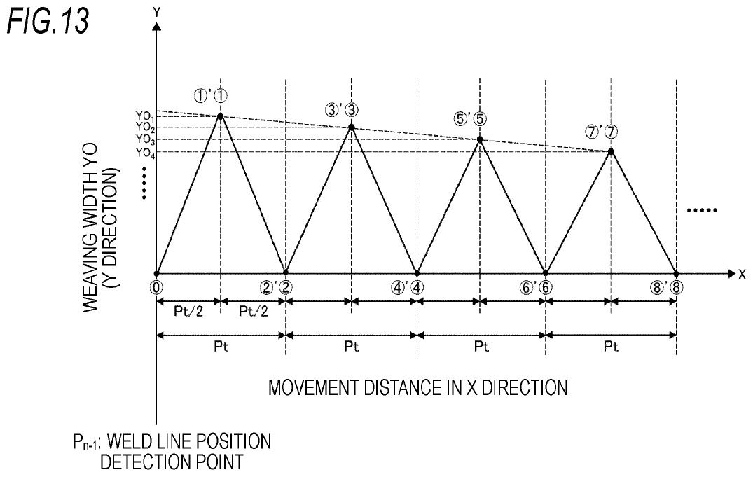

FIG. 12 is a time chart where the both end stop time is set. In the drawing, even when the stop time is provided between the circled figures 1′→1, 2′→2, . . . 8′→8, as in the case of FIG. 10, the welding speed VX and the weaving speed VY repeats the movement where departure and stop are synchronized. FIG. 13 illustrates the weaving pattern here. The positions of the welding torch at the time represented by the circled figures in FIG. 12 are positions represented by the circled figures in FIG. 13. The stop times T1 and T2 are provided at both weaving ends, but the weaving pattern is the same as that of FIG. 11 where the stop time is not provided. During the stop time, the welding torch is controlled to be maintained at both weaving ends without moving.

As a result, the problem described with reference to FIG. 29 is solved. That is, even when the welding torch moves in the weld line direction while the Y-axis direction movement of the welding torch is maintained at both weaving ends based on the set stop time, the concern of lack of penetration in the groove caused when the weaving gap in the X-axis direction is widened due to the effect of the welding speed such that there are locations that the arc cannot reach in the weaving gap is removed.

In the present embodiment, the welding torch can be moved to a target position along a target trajectory at a target time while always maintaining the weaving pattern regardless of the stop time at both weaving ends and regardless of the magnitude of the welding speed. Therefore, the cross-section of the groove 10 can be efficiently filled with weld metal as the original purpose.

### <Control Method of Weaving Accompanied by Movement in Three X, Y, and Z Axis Directions>

In a backing welding method of bonding an insulating material such as ceramic to a back surface of a groove to form a weld bead even on the back side, to reliably form a weld bead on the groove back surface side, that is, a back bead, it is considered to control weaving such that excellent penetration can be obtained in the center portion of the groove.

In the present embodiment, for example, in addition to the basic control method of weaving accompanied by movement in the X-axis direction and the Y-axis direction, weaving can be controlled to operate the welding torch in the Z-axis direction, that is, in the groove depth direction in the weaving center portion such that penetration in the groove center portion is improved. Next, the control method of weaving accompanied by movement in three X, Y, and Z axis directions will be described below.

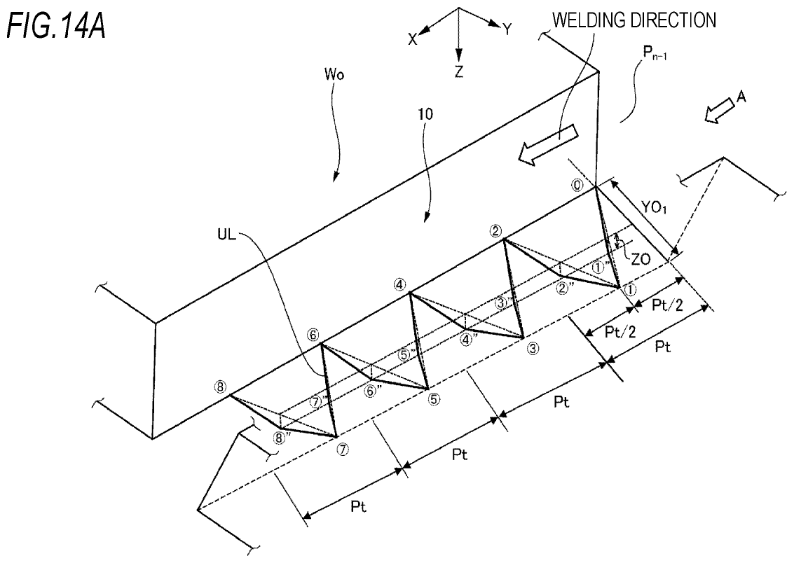

FIGS. 14A and 14B illustrate a weaving pattern in the weaving control method accompanied by movement in the three X, Y, and Z axis directions considering not only the weaving in the Y-axis direction described in the basic control method but also a weaving width in the Z-axis direction that is a groove sheet thickness direction.

As described above, for example, when backing welding is performed, the weaving width ZO in the groove sheet thickness direction is set. The welding torch reciprocates once in the Y-axis direction by the weaving width YO while moving in the X-axis direction by the pitch Pt. Weaving is performed such that the welding torch moves once in the outward path and moves once in the return path, that is, reciprocates once in the Z-axis direction during weaving in the Y-axis direction. As illustrated in FIG. 14A, the circled figures 0→1″→1→2″→2 is a trajectory along which the welding torch moves in the X-axis direction by the pitch Pt. Hereinafter, by repeating the movement for each of the pitches Pt, the robot body 110 travels on the guide rail in the X-axis direction based on the setting of the welding speed VX illustrated in FIG. 8, and the weaving pattern UL is drawn.

A weaving speed VZ in the Z-axis direction satisfies Expressions (16) and (17) by setting the weaving width ZO.

$$\begin{matrix}[ Numeral 16 ] & \\ {VZA}_{k} = \frac{ZO}{{TA}_{k} / 2} & ( 16 )\end{matrix}$$

$$\begin{matrix}[ Numeral 17 ] & \\ {VZB}_{k} = - 1 \cdot \frac{ZO}{{TB}_{k} / 2} & ( 17 )\end{matrix}$$

Here, k represents an integer of 1 to m. Expression (16) represents the weaving speed VZ in the outward path in the Z-axis direction, where TAₖ is obtained from Expression (9). Expression (17) represents the weaving speed VZ in the return path in the Z-axis direction by reversing the signs, where TBₖ is obtained from Expression (10).

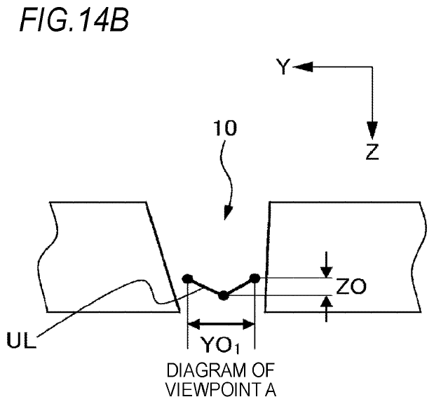

FIG. 15 is a time chart of weaving accompanied by movement in the three X, Y, and Z axis directions. In the drawing, the welding speed VX is obtained from Expressions (11) and (12), the weaving speed VY is obtained from Expressions (13) and (14), and the weaving speed VZ is obtained from Expressions (16) and (17).

In the drawing, circled figures 0 to 8 are the numbers representing the same times as those of FIG. 10 described in the basic control method. In the drawing, the circled figures 1″ to 8″ represent the times when the welding torch is positioned at a weaving end in the Z-axis direction. Not only at both weaving end portions in the Y-axis direction but also at the weaving end portion in the Z-axis direction, the movement speeds in the three X, Y, and Z axis directions are controlled by the respective drive shafts such that departure and stop are synchronized.

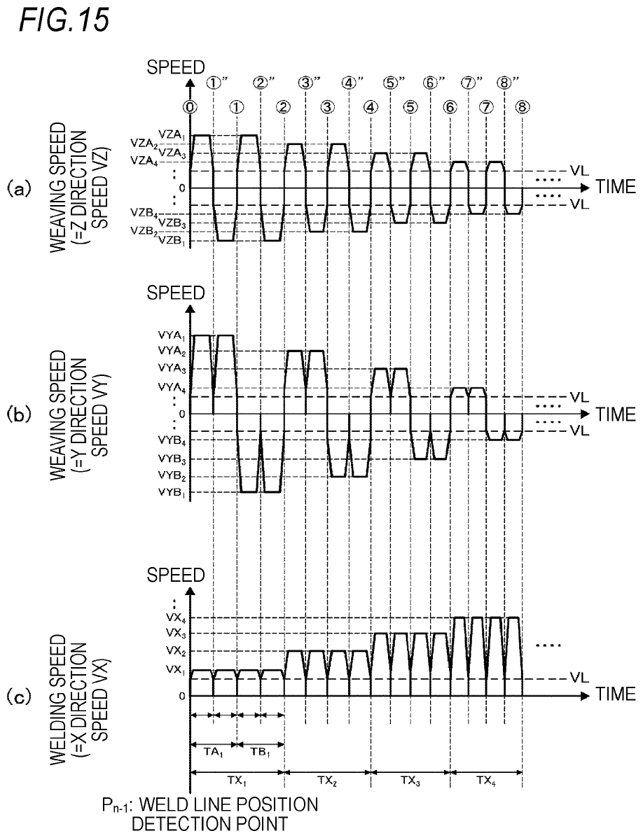

FIG. 16 illustrates the weaving pattern here. The welding torch positions represented by the circled figures in FIG. 15 are represented by the same circled figures in FIG. 16. The circled figures have the same positions as the circled figures in FIG. 14A. In the present embodiment, as in the basic control method, even in weaving accompanied by movement in three X, Y, and Z axis directions, weaving can be performed by reliably moving the welding torch to a target position along a target trajectory at a target time without being affected by the welding speed VX.

As described above, even in weaving accompanied by movement in three X, Y, and Z axis directions, the stop time can be provided at both end portions in weaving in the Y-axis direction. Even in the weaving end portion in the Z-axis direction, the stop time can be set in the same manner that the stop time is provided in both weaving end portions in the Y-axis direction.

### [Control Method of Reciprocating Weaving Speed]

In horizontal welding using the portable welding robot 100, the workpiece Wₒ of FIG. 3 vertically stands, and a positional relationship between the portable welding robot 100 and the workpiece Wₒ does not change. Therefore, by using the weaving settings in flat welding as they are, the basic control method, the control method of the both end stop time, and the weaving control method accompanied by movement in three X, Y, and Z axis directions can be applied.

As features of horizontal welding, a welding wire melted by arc and molten metal of the workpiece Wₒ falls due to the effect of gravity, an appropriate shape of a weld bead cannot be formed, and there is a concern that an excellent weld joint cannot be formed. As a countermeasure, a method of performing a movement of changing the reciprocating weaving speed to prevent the falling of molten metal and pushing up the molten metal with arc can be considered. In other words, a control of the weaving speed during weaving reciprocation is required.

Next, for example, regarding a control method of the reciprocating weaving speed in horizontal welding, the present embodiment will be described. As described above, the control of the reciprocating weaving speed is particularly effective for horizontal welding. Therefore, the present embodiment is described using horizontal welding as an example, but is not limited to horizontal welding, and may be applied to various welding positions.

<Control Method of Reciprocating Weaving Speed that is Effective for Horizontal Welding>

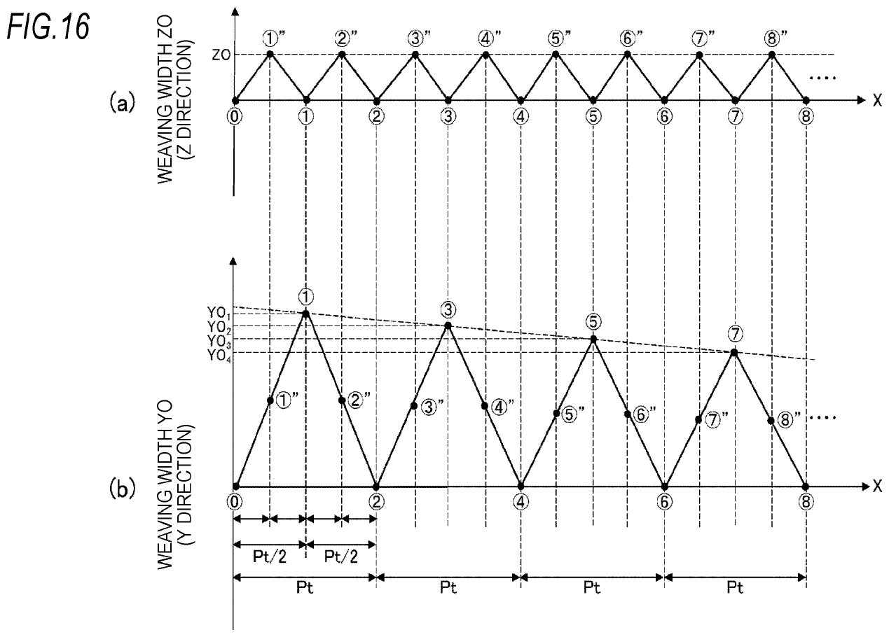

FIG. 17 is a schematic diagram illustrating a weaving pattern in horizontal welding. As described above, in horizontal welding, molten metal falls to the positive side in the Y-axis direction in the drawing due to the effect of gravity. On the other hand, the welding torch vertically swings by weaving in the groove, and when the welding torch moves to the lower side in the groove, that is, the positive side in the Y-axis direction in a direction in which the gravity acts, there is a concern that the falling of molten metal is promoted. Accordingly, the following movement can be performed. When the welding torch moves to the lower side in the groove, the welding torch can be rapidly moved to a lower end stop position of weaving. When the welding torch moves to the upper side in the groove, that is, the negative side in the Y-axis direction opposite to the direction in which the gravity acts, the welding torch can be slowly moved to push up falling molten metal with the arc.

Such weaving control method of changing the movement speed of weaving between the outward path and the return path of weaving will be described.

A case where the weaving speed is the same between the outward path and the return path of weaving is represented by Expressions (13) and (14) in the basic control method described above. In the present embodiment illustrated in FIG. 17, the weaving speed is controlled by providing a weaving speed ratio between the movement to the outward path of weaving, that is, the positive side in the Y-axis direction and the movement to the return path, that is, the negative side in the Y-axis direction.

When the weaving speed ratio is represented by G, a relationship represented by Expression (18) is established.

$$\begin{matrix}[ Numeral 18 ] & \\ {VYB}_{k} = G \cdot {VYA}_{k} & ( 18 )\end{matrix}$$

Here, VYAₖ represents the weaving speed of the outward path, VYBₖ represents the weaving speed of the return path, and k represents an integer of 1 to m. Expression (18) represents that the weaving speed VYBₖ of the return path is G times of the weaving speed VYAₖ of the outward path.

Accordingly, even when the reciprocating weaving speed is changed, the time TX for which the welding torch moves in the X-axis direction by the pitch Pt needs to be maintained. The reason is to prevent the welding time between the weld line position detection points (Pₙ₋₁, Pₙ) from changing regardless of an increase or decrease in weaving speed. Therefore, while maintaining the time TX, the movement times in the outward path and the return path of weaving needs to be controlled according to an increase or decrease in weaving speed.

That is, when a time required for the welding torch to move in the outward path by the weaving width YO is represented by TA and a time required for the welding torch to move in the return path by the weaving width YO is represented by TB, relationships of Expressions (19) and (20) are established.

$$\begin{matrix}[ Numeral 19 ] & \\ {TA}_{k} = \frac{G}{G + 1} \cdot {TX}_{k} & ( 19 )\end{matrix}$$

$$\begin{matrix}[ Numeral 20 ] & \\ {TB}_{k} = \frac{1}{G + 1} \cdot {TX}_{k} & ( 20 )\end{matrix}$$

Here, k represents an integer of 1 to m. TXₖ is obtained from Expression (8).

The weaving speeds in the outward path and the return path are obtained from the following Expressions (21) and (22) by dividing the weaving width YO by the times of Expressions (19) and (20).

$$\begin{matrix}[ Numeral 21 ] & \\ {VYA}_{k} = \frac{G + 1}{G} \cdot \frac{{YO}_{k}}{{TX}_{k}} & ( 21 )\end{matrix}$$

$$\begin{matrix}[ Numeral 22 ] & \\ {VYB}_{k} = - 1 \cdot ( G + 1 ) \cdot \frac{{YO}_{k}}{{TX}_{k}} & ( 22 )\end{matrix}$$

VYA of Expression (21) represents the movement speed of the weaving outward path that is the movement to the positive side in the Y-axis direction, and VYB of Expression (22) represents the movement speed of the weaving return path that is the movement to the negative side in the Y-axis direction by reversing the signs. YOK is obtained from Expression (7).

Likewise, the speed at which the welding torch moves in the X-axis direction by the pitch Pt is divided into the speeds in the outward path and the return path of weaving in the Y-axis direction, which are obtained from the following Expressions (23) and (24) by dividing ½ of the pitch Pt by the values of Expressions (19) and (20).

$$\begin{matrix}[ Numeral 23 ] & \\ {VXA}_{k} = \frac{G + 1}{G} \cdot \frac{Pt / 2}{{TX}_{k}} & ( 23 )\end{matrix}$$

$$\begin{matrix}[ Numeral 24 ] & \\ {VXB}_{k} = ( G + 1 ) \cdot \frac{Pt / 2}{{TX}_{k}} & ( 24 )\end{matrix}$$

Here, k represents an integer of 1 to m. VXA of Expression (23) represents the movement speed in the X-axis direction at which the welding torch moves to the positive side in the Y-axis direction in the outward path by the weaving width YO, and VXB of Expression (24) represents the movement speed in the X-axis direction at which the welding torch moves to the negative side in the Y-axis direction in the return path by the weaving width YO.

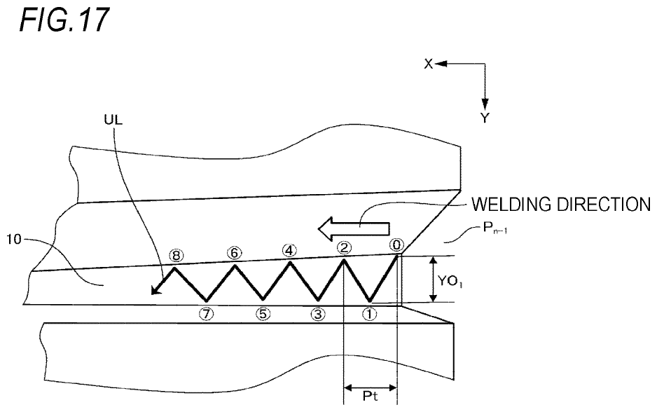

FIG. 18 is a time chart representing Expressions (19) to (24). As in the basic control method of flat welding, at the times of the circled figures 0 to 8 in the drawing, the timings of departure and stop in the X and Y-axis directions are synchronized, and while maintaining the time TX for which the welding torch moves in the X-axis direction by the pitch Pt by the speed ratio G between the outward path and the return path of weaving, the weaving speed VY and the welding speed VX change. In the pitch Pt, although the welding speed VX changes, the welding time between the weld line position detection points (Pₙ₋₁, Pₙ) does not change, and the distance DX does not change. Therefore, the welding speed VX as a whole does not change.

Here, the weaving pattern is the same as that of FIG. 11 illustrating the basic control method of flat welding. In the present embodiment, even when the weaving speed changes as described above, as in the basic control method, weaving can be performed by reliably moving the welding torch to a target position along a target trajectory at a target time.

### <Control Method of Special Weaving Pattern>

As described above, as features of horizontal welding, a welding wire melted by arc and molten metal of the workpiece Wₒ falls due to the effect of gravity, it is difficult to obtain an appropriate shape of a weld bead, and there is a concern that an excellent weld joint cannot be obtained. As a countermeasure, the weaving control method of performing a movement of changing the reciprocating weaving speed to prevent the falling of molten metal and pushing up the molten metal with the arc is described above.

The action of pushing up the falling molten metal with the arc can also be performed by changing the weaving pattern to a special trajectory. Accordingly, regarding the control method of the special weaving pattern, the present embodiment will be described using an example where a serrated weaving pattern is used as the special weaving pattern. The control of the special weaving pattern is not limited to horizontal welding and may be used for various welding positions.

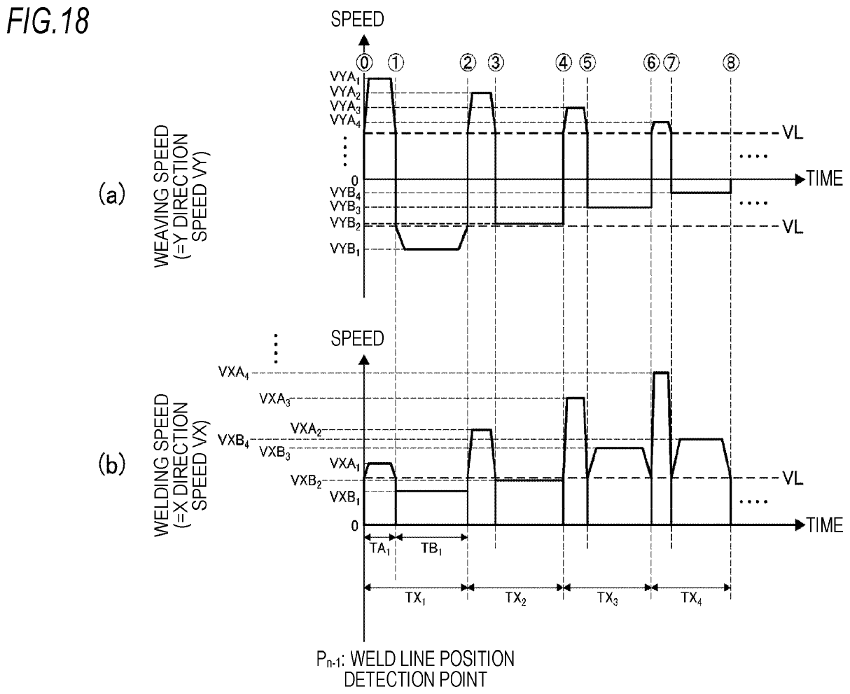

FIG. 19 is a schematic perspective view illustrating the special weaving pattern that is effective for horizontal welding. Even when the welding torch in the groove 10 moves in a serrated shape, the cross-section of the groove 10 can be appropriately filled with molten metal. Patent Literature 1 also describes that the serrated weaving pattern can be implemented by the welding device using an articulated robot. However, in the present embodiment, the serrated weaving pattern can be implemented by combining the driving in the X-axis direction and the driving in the Y-axis direction in the portable welding robot 100.

The serrated weaving pattern according to the present embodiment can be formed based on a setting of shifting the upper end portions represented by the circled figures 1, 3, 5, and 7 in FIG. 11 in the weaving pattern described in the basic control method in the X-axis direction. Here, the shift amount is set to XO.

Even in the control method, the weaving width, time, and speed of the welding torch in the Y-axis direction are the same as those in the basic control method. The weaving width is obtained from Expression (7), the weaving times are obtained from Expressions (9) and (10), and the weaving speeds are obtained from Expressions (13) and (14).

On the other hand, regarding the movement distance in the X-axis direction, for the time for which the welding torch moves in the weaving outward path, the welding torch moves in the X-axis direction by a distance obtained by adding the shift amount XO to ½ of the pitch Pt. Conversely, for the time for which the welding torch moves in the weaving return path, the welding torch moves in the X-axis direction by ½ of the pitch Pt but additionally move by the shift amount XO. Therefore, the welding torch needs to return by the shift amount XO. When the movement speeds in the X-axis direction by ½ of the pitch Pt are obtained from the relationships, the movement speeds are as represented by the following Expressions (25) and (26).

$$\begin{matrix}[ Numeral 25 ] & \\ {VXA}_{k} = \frac{( Pt / 2 + XO )}{{TA}_{k}} & ( 25 )\end{matrix}$$

$$\begin{matrix}[ Numeral 26 ] & \\ {VXB}_{k} = \frac{( Pt / 2 - XO )}{{TB}_{k}} & ( 26 )\end{matrix}$$

Here, VXA of Expression (25) represents the movement speed in the X-axis direction at which the welding torch moves in the weaving outward path. VXB of Expression (26) represents the movement speed in the X-axis direction at which the welding torch moves in the weaving return path. In the expression, TAₖ is obtained from Expression (9), and TBₖ is obtained from Expression (10). Here, k represents an integer of 1 to m.

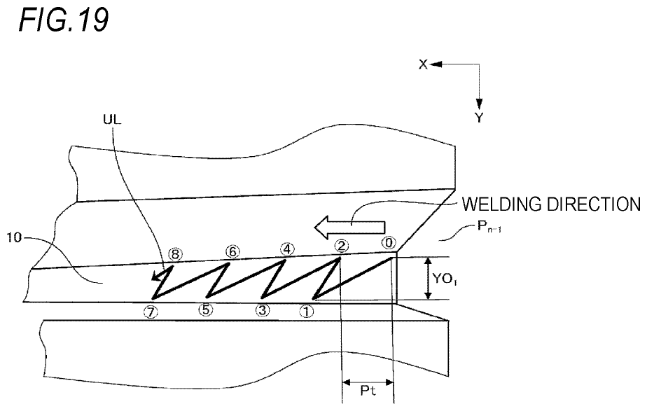

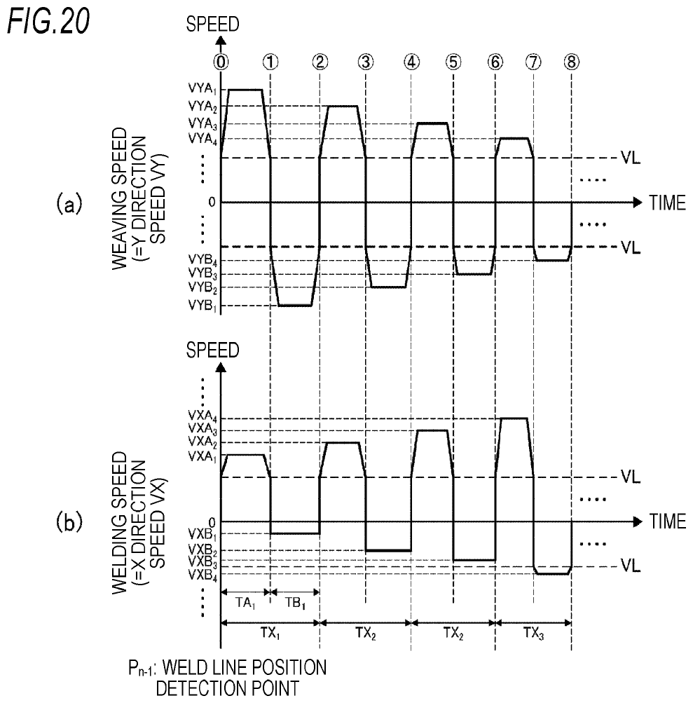

FIG. 20 is a time chart illustrating Expressions (13), (14), (25), and (26), and FIG. 21 illustrates the weaving pattern here. Circled figures in FIG. 20 are the same as those of FIG. 10 of the basic control and represent the times at which departure and stop in the X-axis direction and the Y-axis direction are synchronized, and positions of the welding torch here correspond to positions of the same circled figures as those of FIG. 21 and FIG. 19.

Although depending on the value of the shift amount XO, as can be seen from FIG. 20, the speed in the X-axis direction at which the welding torch moves in the weaving return path is a negative value. That is, it represents the movement of the welding torch that returns in the direction opposite to the welding direction. By performing such movement, weaving is performed along a serrated trajectory as can be seen from the weaving pattern of FIG. 21. Triangles that form the serrated shape, that is, shapes formed by the circled figures 0, 1, and 2, the circled figures 2, 3, and 4, the circled figures 4, 5, and 6, and the circled figures 6, 7, and 8 can vary according to the value of the shift amount XO.

Of course, the welding speed VX is set to a negative value in the pitch Pt. However, the welding time between the weld line position detection points (Pₙ₋₁, Pₙ) does not change, and the distance DX does not change. Therefore, the welding speed VX as a whole does not change.

In the present embodiment, even when the serrated weaving is performed, the welding torch can be controlled to a target position along a target trajectory at a target time.

[Control Method of Weaving Pattern that is Effective for Vertical Welding]

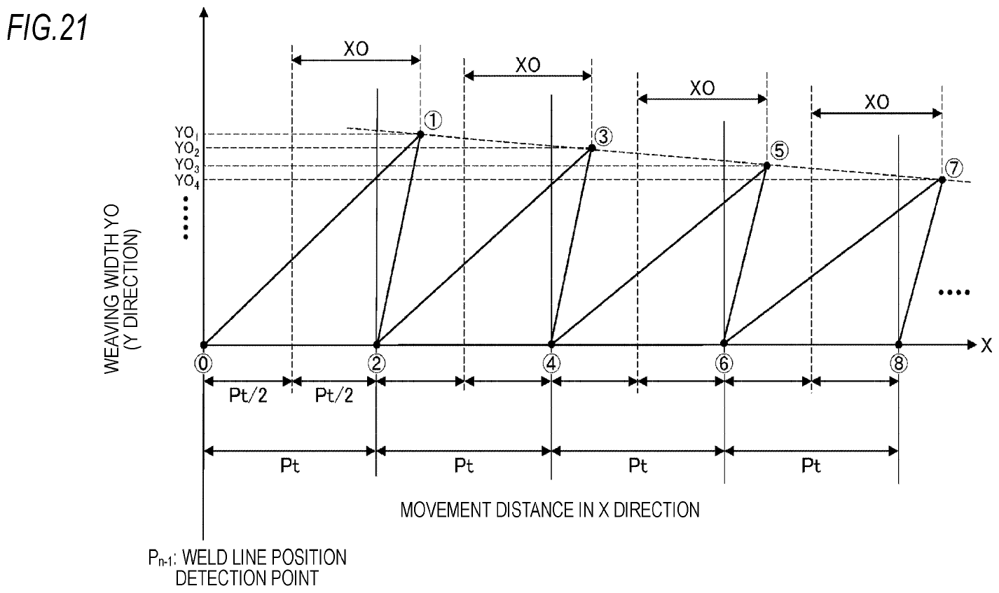

FIG. 22 is a perspective view illustrating vertical welding using the portable welding robot 100. A positional relationship between the portable welding robot 100 and the groove 10 of the workpiece Wₒ does not change from that of FIG. 3 illustrating flat welding. Therefore, the weaving settings in flat welding can be used as they are, and the basic control method, the control method of the both end stop time, and the weaving control method accompanied by movement in three X, Y, and Z axis directions can be applied.

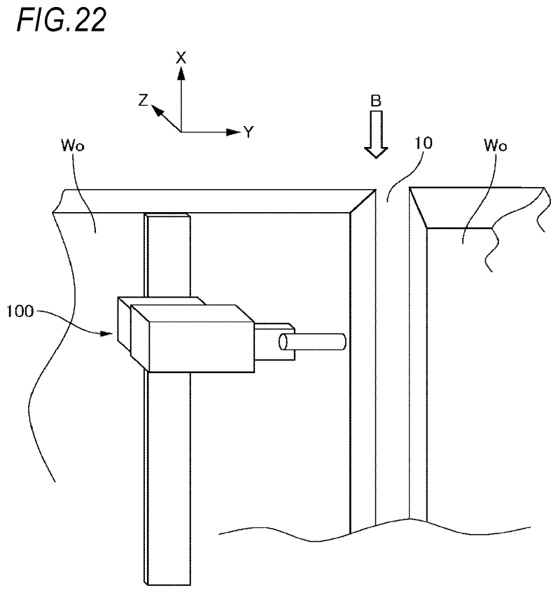

FIGS. 23A to 23C illustrate a weaving pattern for vertical welding in the present embodiment. FIGS. 23A to 23C are diagrams when seen from a viewpoint B of FIG. 22, and illustrate the weaving patterns UL formed by the basic control, the control of the both end stop time, and the weaving control accompanied by movement in three X, Y, and Z axis directions.

In vertical welding, molten pool formed of molten metal is likely to fall to outside of the groove that is a negative side in the Z-axis direction, and heat input to a wall of the groove 10 is small, and penetration may be insufficient in some cases. Here, the welding torch can also be weaved along the wall of the groove 10 such that penetration is likely to occur on both side walls of the groove 10. As illustrated in FIG. 23C, two stop positions in the Z-axis direction can be set by applying the weaving control method accompanied by movement in three X, Y, and Z axis directions. The stop time can also be set at any of the stop positions.

FIG. 24 collectively illustrates a relationship between the weaving pattern of the weaving control accompanied by movement in three X, Y, and Z axis directions described above and the welding speed VX and the weaving speeds VY and VZ.

### [Weaving Control Method Using Approximate Linear Movement Mechanism]

Incidentally, the portable welding robot 100 according to the present embodiment includes the approximate linear movement mechanism 180 (refer to FIG. 4) that can substantially linearly drive the tip of the welding wire 211 in the X-axis direction while tilting the welding torch 200. Here, a movement direction of the portable welding robot 100 along the guide rail 120 by the X-axis movement mechanism will be referred to as an XA direction, and a movement direction of the welding torch 200 by the approximate linear movement mechanism 180 will be referred to as an XB direction to distinguish between the directions for description.

When a face plate such as a ceramic tab or a steel tab that stops molten pool is provided at a groove starting end or a groove terminal end, the welding torch 200 is laid down in a longitudinal direction of the groove using the approximate linear movement mechanism 180, the welding wire tip is caused to face a corner joint of base metal and the face plate, and welding residues of the groove end portion can be reduced.

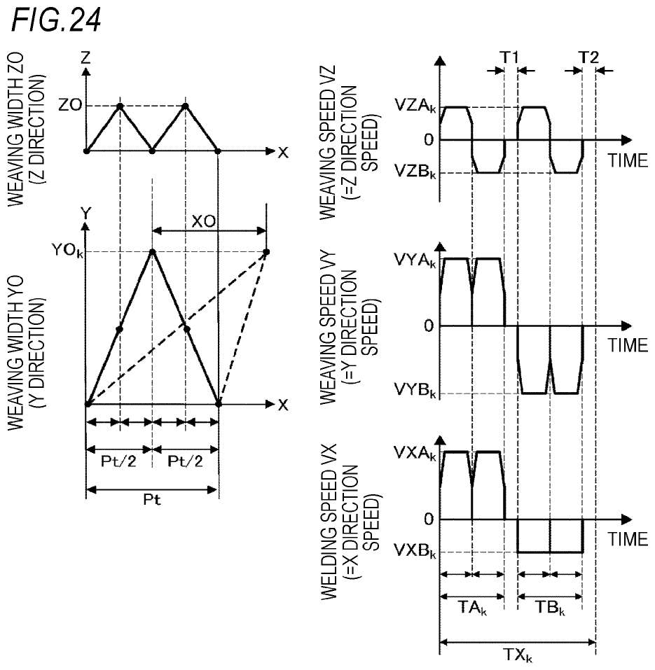

That is, as illustrated in FIG. 25, when a face plate 350 is provided on a surface of the welding start point 10s, as represented by a circled FIG. 1 in the drawing, a welding point of the welding torch 200 that is automatically or manually tilted aims at a groove starting end to start groove welding, the welding wire tip is moved in the XB direction by the approximate linear movement mechanism 180, and the tilt of the welding torch 200 is returned until an appropriate welding torch angle represented by a circled FIG. 2 in the drawing is reached. When the appropriate welding torch angle is reached, welding is continued in the XA direction until immediately before a groove terminal end represented by a circled FIG. 3 by the X-axis movement mechanism. The welding torch 200 is tilted again by the approximate linear movement mechanism 180 to automatically perform welding until a groove terminal end represented by a circled FIG. 4. Even when the movement of the tip of the welding wire 211 in the XB direction is replaced with the movement in the XA direction by the X-axis movement mechanism described above, the same weaving control can be performed.

A rotation control method of the welding torch can be performed, in which, by setting the movement speeds in the XA direction and the XB direction to be the same and setting only the movement directions to be opposite to each other, the torch angle of the welding torch 200 is controlled to rotate substantially without changing the position of the tip of the welding wire 211.

### <Rotation Control Method of Welding Torch>

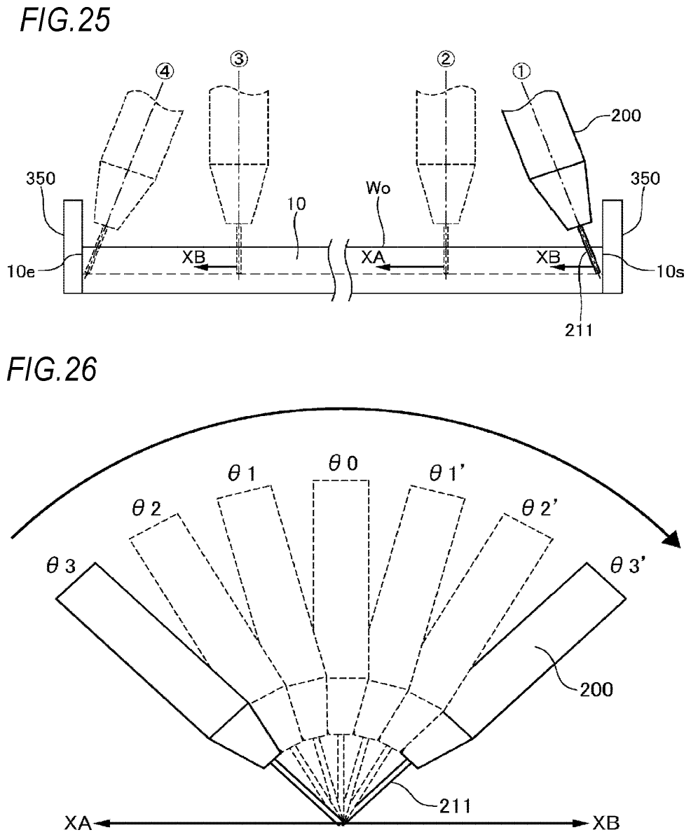

FIG. 26 schematically illustrates a movement of the welding torch when the torch angle of the welding torch is controlled to rotate by setting the movement speeds in the XA direction and the XB direction to be the same and setting only the movement directions to be opposite to each other. As a result, the welding torch 200 can be rotated substantially without changing the position of the tip of the welding wire 211. Therefore, for example, when the welding torch is set at a push angle represented by θ3 in the drawing to perform welding in a direction toward the right of the paper plane, for example, when the groove is continuously folded and welded from the welding terminal end portion, the rotation control method is applied such that the torch angle of the welding torch can be changed to the push angle in the welding direction represented by θ3′ in the drawing to continuously perform welding as it is without changing the tip position of the welding wire 211 at the welding terminal portion.

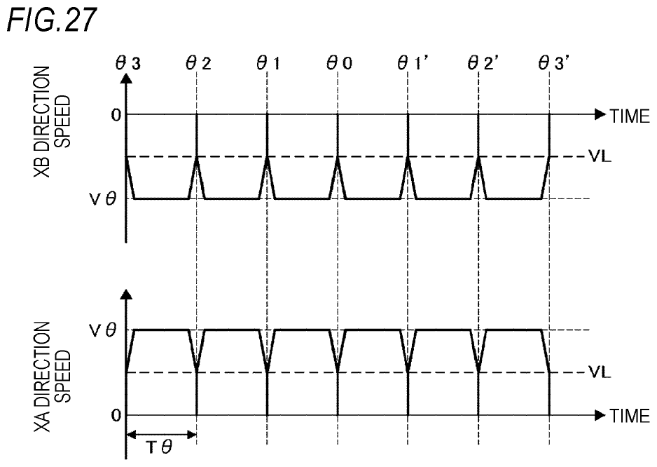

FIG. 27 illustrates a time chart here. In the XA direction, departure and stop are repeated at intervals of a time TO based on a setting of a speed Vθ. In the XB direction, by repeating the opposite directional movement at a negative speed Vθ at the same interval as that of the XA direction to cancel out the movement in the XA direction, the movements in the XA direction and the XB direction are canceled out by each other, and the torch angle of the welding torch 200 can be changed to rotate without changing the position of the welding wire tip. The speed Vθ and the time Tθ are set in a range not affecting welding.

The present invention is not limited to the above-described embodiment, and modifications, improvements, and the like can be appropriately made.

Hereinabove, various embodiments have been described with reference to the drawings, but it is needless to say that the present invention is not limited to the examples. It is obvious to those skilled in the art that various modification examples or alteration examples can be conceived within the scope of the claims, and it is understood that such examples also fall within the technical scope of the present invention. Within a range not departing from the scope of the invention, the respective components of the above-described embodiment can be combined as appropriate.

The present application is based on Japanese Patent Application No. 2021-156169 filed on Sep. 24, 2021, the content of which is incorporated herein by reference.

### REFERENCE SIGNS LIST

Fₙ: groove shape detection position
G: speed ratio between outward path and return path
Pₙ: weld line position detection point
VXPₙ: welding speed at weld line position detection point Pₙ
YOPₙ: weaving width at weld line position detection point Pₙ
Pt: pitch (reference distance)
T1, T2: stop time
Tsu1: acceleration time (rising period)
Tsu2: deceleration time (falling period)
UL: weaving pattern
VH: set speed (second speed set value)
VL: initial speed (first speed set value)
VX: welding speed (X-axis direction speed)
VY: weaving speed (Y-axis direction speed)
VZ: weaving speed (Z-axis direction speed)
WL: weld line
Wₒ: workpiece
XO: shift amount
YO: weaving width
ZO: weaving width
θ3: torch angle
10: groove
50: welding system
100: portable welding robot
120: guide rail
180: approximate linear movement mechanism
181: X-axis movement mechanism (movement mechanism that moves portable welding robot along guide rail)
182: Y-axis movement mechanism (mechanism for movement in groove width direction)
183: Z-axis movement mechanism (mechanism for movement in groove depth direction)
600: control device (welding control device)

1. A weaving control method for welding a workpiece having a groove using a portable welding robot that moves on a guide rail, the weaving control method comprising:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, wherein
an instruction of a stop signal and an instruction of a departure signal to be given immediately after instructing the stop signal or after the lapse of a predetermined stop time under the speed condition of each of the plurality of direction components calculated in the speed condition calculation step are synchronized with each other at least when a weaving end is reached.

2. The weaving control method according to claim 1, wherein
the direction component is selected from at least two of a weld line direction of the workpiece, a groove width direction perpendicular to the weld line direction, and a groove depth direction perpendicular to each of the weld line direction and the groove width direction.

3. The weaving control method according to claim 2, wherein:
an X-axis movement mechanism that moves the portable welding robot along the guide rail is provided as a mechanism in the robot movement mechanism for moving the portable welding robot in the weld line direction; and
a Y-axis movement mechanism and a Z-axis movement mechanism in the portable welding robot are provided as mechanisms in the robot movement mechanism for moving the portable welding robot in the groove width direction and the groove depth direction, respectively.

4. The weaving control method according to claim 3, further comprising an approximate linear movement mechanism in the portable welding robot that is provided as a mechanism for moving the portable welding robot in the weld line direction.

5. The weaving control method according to claim 1, wherein
a first speed set value VL and a second speed set value VH that is larger than the first speed set value VL and varies depending on weaving widths are provided as the speed condition for each of the direction components, in the speed condition from the instruction of the departure signal to the instruction of the stop signal, a speed condition process of providing the first speed set value VL after the departure signal, providing the second speed set value VH after the first speed set value VL, providing the first speed set value VL again after the second speed set value VH, and providing the stop signal after the first speed set value VL that is provided again, is repeated whenever the departure signal is instructed.

6. The weaving control method according to claim 5, wherein
when a period from the first speed set value VL to the second speed set value VH is set as a rising period and a period from the second speed set value VH to the first speed set value VL that is provided again is set as a falling period, an absolute value of a slope of the speed condition in each of the rising period and the falling period is a fixed value.

7. The weaving control method according to claim 2, wherein the condition of the weaving reference trajectory includes, as the reference distance for determining the weaving pattern, a pitch Pt that is a distance between the weaving ends adjacent to each other on one side with respect to a weld center line.

8. The weaving control method according to claim 7, wherein the weaving reference trajectory is determined such that the weaving end is positioned at Pt/2 that is ½ of Pt.

9. The weaving control method according to claim 8, wherein
when the instruction of the stop signal and the instruction of the departure signal are provided at positions other than the weaving end, the instruction of the stop signal and the instruction of the departure signal are provided between the weaving end and Pt/2.

10. The weaving control method according to claim 8, wherein the condition of the weaving reference trajectory includes at least one of the direction components as a shift amount that is set for shifting a position of the weaving end on one side positioned at Pt/2.

11. The weaving control method according to claim 9, wherein
the condition of the weaving reference trajectory includes at least one of the direction components as a shift amount that is set for shifting a position of the weaving end on one side positioned at Pt/2.

12. The weaving control method according to claim 10, wherein: the direction component for setting the shift amount is at least the weld line direction; and
the position of the weaving end is shifted in a welding direction of the weld line direction.

13. The weaving control method according to claim 11, wherein:
the direction component for setting the shift amount is at least the weld line direction; and
the position of the weaving end is shifted in a welding direction of the weld line direction.

14. The weaving control method according to claim 2, wherein when a torch angle at the stop of the welding or during the welding changes,
a mechanism in the robot movement mechanism for moving the robot movement mechanism in the weld line direction is configured by an X-axis movement mechanism that moves the portable welding robot along the guide rail and an approximate linear movement mechanism in the portable welding robot, and
a movement speed of the portable welding robot in the weld line direction is controlled by a combination of a movement speed based on the X-axis movement mechanism and a movement speed based on the approximate linear movement mechanism.

15. The weaving control method according to claim 2, wherein the condition of the weaving reference trajectory includes at least one of a stop time at each of the weaving ends, a weaving width in the groove width direction, a weaving width in the groove depth direction, and a speed ratio between an outward path and a return path in the weaving.

16. A welding control device used in weaving control for welding a workpiece having a groove using a portable welding robot that moves on a guide rail, the welding control device comprising:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, wherein
the welding control device has a function of synchronizing an instruction of a stop signal and an instruction of a departure signal to be given immediately after instructing the stop signal or after the lapse of a predetermined stop time under the speed condition of each of the plurality of direction components calculated in the speed condition calculation step with each other at least when a weaving end is reached.

17. A welding system comprising the welding control device according to claim 16.

18. A welding method using the welding system according to claim 17.

19. A non-transitory computer-readable medium storing a weaving control program, which when executed by circuitry, causes the circuitry to perform weaving control for welding a workpiece having a groove using a portable welding robot that moves on a guide rail, the weaving control program causing the circuitry to perform a method comprising:
a setting step of setting at least a condition of a weaving reference trajectory relating to a reference distance for determining a weaving pattern; and
a speed condition calculation step of calculating a speed condition for giving an instruction to a robot movement mechanism that moves the portable welding robot for each of a plurality of predetermined direction components based on the weaving pattern determined based on the setting step, wherein
the weaving control program executes a function of synchronizing an instruction of a stop signal and an instruction of a departure signal to be given immediately after instructing the stop signal or after the lapse of a predetermined stop time under the speed condition of each of the plurality of direction components calculated in the speed condition calculation step with each other at least when a weaving end is reached.
